(19) United States
(12) Patent Application Publication
(10) Pub. No.: US 2003/0177027 A1
(43) Pub. Date: Sep. 18, 2003

(54) Multi-purpose talent management and career management system for attracting, developing and retaining critical business talent through the visualization and analysis of informal career paths

(76) Inventor: Anthony M. DiMarco, Poughkeepsie, NY (US)

Correspondence Address: Joseph L. Spiegel, 272 Mill Street, Poughkeepsie, NY, 12601, US

(21) Appl. No.: 10/379,188

(22) Filed: Mar. 6, 2003

Related U.S. Application Data
(60) Provisional application No. 60/363,002, filed on Mar. 8, 2002.

(51) Int. Cl. G06F 17/60

(52) U.S. Cl. 705/1

(57) ABSTRACT

A multi-purpose talent management and career management system and method that helps organizations attract, develop and retain critical talent through computer aided visualization and analysis of informal career paths of individuals. Historical career data is collected from an individual and a visual history of their career path is created via graphical views that include career, job and project experiences as well as competencies such as roles, skills, and knowledge. Individuals can use views for career self-assessment, and to develop a differentiating “visual resume”, and to expand their viable career options. Organizations can use these views to recruit talent by helping candidates understand the informal career paths of the organization. The data used to construct the views is stored in a relational database that can be searched to identify talent that meets search criteria. The data can be analyzed to determine a variety of talent metrics such as career and job mobility.

### CROSS REFERENCE TO RELATED APPLICATION

This non-provisional application is related to and claims the benefit of U.S. provisional application Serial No, 60/363,002 filed Mar.

### BACKGROUND OF THE INVENTION

1. Field of the Invention

The world of work is changing rapidly. The world of work today requires a different kind of worker—the knowledge worker. Their value lies in their head not in what they can do with their hands. Their competencies drive value independent of the organizational setting. They are empowered to make decisions in their areas of responsibility. They create their own work and shape their own careers. They are motivated by intellectual challenges and growth opportunities. They need to continually learn new technologies, tools, and organization structures through diverse career and job experiences. (See Edward Michaels, Helen Hanfield-Jones, and Beth Axelrod, “The War for Talent”, Chapter 1, pp. 1-17; Boston: Harvard Business School Press, 2001)

The power is shifting from employers to knowledge workers. Knowledge is now the productive asset of modem society and knowledge resides in people's head that are not owned by the employer. Supply and demand will continue to favor the knowledge worker over the next 20 to 30 years. The shortage of knowledge workers with Bachelors degrees is expected to be 3.6 million by 2010 and 10.5 million by 2020. (See Elizabeth Chambers, Mark Foulon, Helen Handfield-Jones, Steve Hankin, and Edward Michaels, “The War for Talent,” in The McKinsey Quarterly, 1998 Number 3,p pp.45-57.)

Knowledge workers have more options available to them today with more companies, new forms of employment that include free agency, and new jobs that did not exist just a few years ago (e.g. webmaster). Societal norms have even shifted, making it more acceptable and even desirable for people to change jobs more often. There used to be a social stigma associated with changing jobs too often, now the social stigma is with those who stay with one company or one job too long.

The result is increased career and job mobility of the knowledge worker It is now estimated that students graduating college today will have four to five career—not job—changes during their lifetime and that 50-60% of all new college hires leave their jobs within the first seven months. The results of these dynamics have been dubbed the “war for talent”. As a result of the power shifting away from the employer to the employee, companies must now tailor their brand and the jobs it has to offer, in order to appeal to the specific people (talent) they want to attract and retain. Career mobility is a major factor in attracting and retaining talent. 39% of 200 executives in a survey rated this factor absolutely essential as a reason to join a company, ranking fifth highest out of 19 factors. Career mobility thus becomes a critical part of the employee value proposition that the company must communicate and honor. (See “Engaging Employees Through Your Brand,” in a report by The Conference Board, Research Report 1288-01-RR, pp. 5-37, 2001)

Increased career mobility means that the company must make it easier for their employees to change projects, jobs and careers within the company as a way of fulfilling the needs of employees to find work that is satisfying to them and that provides them with personal and professional growth opportunities. This career mobility is often non-traditional, meaning it does not necessarily follow the well planned, structured and prescribed vertical career paths within a specific discipline, often referred to as “climbing the career ladder”. Most career paths today are emergent—they are non-traditional and follow no visible, supported career path. They are informal and invisible because they are not easy to visualize or predict in advance. They are more like emergent patterns that may be horizontal, diagonal, zigzag, A-shape, T-shape and many other patterns nowhere close to resembling a career ladder. Organizations need ways to make these informal career patterns visible and ways to analyze and understand them.

Organizations will need to offer the employee career self-assessment services that allow individuals to become more aware of their natural talents and transferable skills, knowledge and roles in order to help the individual become more agile and more capable of moving and quickly adapting to new career opportunities. It will also require the knowledge worker to be constantly scanning the environment for potential career opportunities and to expand the career options that are viable for them. Being able to view the informal career paths of others can help them to identify new career paths that are potentially open to them. Companies will need to respond to these sets of need with ever more sophisticated online recruiting capabilities to attract candidates in ways that differentiate their company among their key talent competitors. This is especially true when trying to attract pre-professional or early professionals who have come to see the Internet as a significant vehicle for finding a job. (See Peter Capelli, “Making the Most of On-Line Recruiting,” in Harvard Business Review, March 2001, pp. 6-12). Organizations will need to create an efficient internal market for talent where there is constant movement of people (i.e. career and job mobility) towards jobs that are optimized to their talent. In this efficient market they will also need to find ways of making the “buyers” and “sellers” of talent more visible to each other by making visible the informal career paths of those in the organization and by being better able to broker connections between these two parties.

The present invention is a powerful multi-purpose talent management and career management system and method that can be applied across human resource (HR) functions in organizations, across functions in academic institutions, and applied to broader markets that include individuals (both professionals and pre-professionals), affinity groups (e.g. professional associations, corporate alumni), executive recruiters (i.e. head hunters), employment agencies, career centers and career coaches, and economic development agencies.

The present invention in the area of talent management and career management within companies includes a multi-purpose approach to addressing a variety of HR issues, across HR, such as talent management, staffing, management development and employee development. Companies have a strategic need to encourage and demonstrate career mobility within the organization in order to more effectively attract, develop and retain critical talent. The present invention meets these needs by providing talent management and career management functionality such as informal career path visualization, computer-aided career self-assessment and sophisticated talent search and talent analysis capabilities.

The present invention similarly addresses the needs of academic institutions that are trying to attract high potential high school students or advanced degree candidates to their institution and specific degree programs. It similarly provides talent management capabilities for external job markets that include professional associations, corporate and academic alumni communities, headhunter and executive recruiting firms, and local talent markets such as regional economic development councils. Just as in the internal talent markets of corporations, talent in these external markets can be visualized, searched, and analyzed thus enhancing the career mobility within these external markets.

The computer aided career self-assessment tools and informal career path visualization capabilities are important to individuals for the purpose of career management. Individuals can access the career management capabilities of this present invention either within their own companies or independent of their companies either directly through web-based services or indirectly through intermediaries that might include career centers or career coaches. Individuals, including both professionals and pre-professionals (i.e. high school and college students) can benefit by viewing the informal career paths of others in order to make more informed career decisions and to increase the career options open to them.

2. Description of the Prior Art

The dynamics and challenges of the new world of work described above have created a comprehensive set of needs that are currently not being met by existing HR organizations and HR systems. Current HR systems continue to focus narrowly on one functional area at a time such as staffing, management development or employee development. Current HR systems are not multi-purpose and do not effectively meet both the talent management and career management needs within an organization.

For example, HR systems may focus narrowly on the managing the recruiting process or workflow (E.g. Yahoo!Resumix, Recruitmax), on identifying recruitment candidates through external resume boards (E.g. Monster.com, Hotjobs.com), on providing employee profiles based on demographics and providing workforce analytics (e.g.,. PeopleSoft, Spherion), or on assessing skills (E.g. SkillView.com, Trifus). Many of the most integrated systems (e.g., PeopleSoft) focus on financially oriented HR applications such as benefits administration, payroll solutions, and pension administration. They do not have multi-purpose capabilities that can meet a broad set of HR needs across talent management, staffing, career development, career management, management development and employee development. This is in part because many of the systems developed above were put in place before the emergence of talent management as a business and application area that cuts across many of the traditional and narrow HR applications they targeted.

A common approach is disclosed in U.S. Pat. No. 5,197,004 by Sobotka et al., entitled “Method and Apparatus for Automatic Categorization of Applicants from Resumes.” In this approach, resume based solutions deal with traditional resumes in traditional ways such as inputting a computer readable version of the text and doing text mining to interpret and assess the relevancy of a resume for a particular job. They are limited by the unstructured and inconsistent approaches used by resume authors and the system does not lend itself easily to relational data and searches but is limited to text and keyword searches. Another related approach is disclosed in U.S. Pat. No. 5,758,324 by Hartman et al., entitled “Resume Storage and Retrieval System”. It takes a traditional resume and breaks it down into components and stores those components in a database for retrieval. This is an improvement over the method in U.S. Pat. No. 5,197,004 but it is still limited to the unstructured and inconsistent resume source material that impacts the effectiveness of any relational searches. It helps employers more effectively sort, store and retrieve resume content but does not provide a resume system that is relational from the point of creation. It does not provide the viewers of the resume a quick visual career history or the ability to quickly select a job to view only the resume data for that job. Nor does it allow the owners of the resume an effective visual approach to conveying their career histories to others in a visual snapshot. The prior art methods in the two patents described above are limited to the inconsistent data included on a traditional resume and are not extendable to other applications such as computer aided self-assessment based on information not found on resumes such as strengths, weaknesses, lessons learned, etc. They cannot be used for visualizing and analyzing informal career paths or for communicating career mobility on online recruiting sites. These examples of prior art are not multi-purpose in supporting broad talent management and career management applications.

These same limitations impact the effectiveness of external resume boards (e.g. Monster.com, HotJobs.com) and the systems and methods they are based on since they are tied to the same traditional resume source materials. An example of such a system and approach is disclosed in U.S. Pat. No. 5,978,768 by McGovern et al., entitled “Computerized Job Search System and Method for Posting and Searching Job Openings via a Computer Network.” This is an employment recruiting method and approach based on matching information pertaining to a job opening with information provided by a user on the types of jobs preferred and a method for informing the user when there is a potential match. Unlike most traditional external resume boards, this approach does not store all of the resume and job openings but when there is a perceived match, it passes resumes directly through to the company and passes the job description through to the individual. This is an improvement since it provides additional privacy to both the company and the individual. It does not provide for anonymous higher level visual representations of an individual's career experiences that can help an employer quickly search and assess a broad base of potential candidates. Because of the lack of anonymity of the resume owner, it will cause the recruiters to see primarily active job seekers and not the often more valuable and highly desirable passive job seekers since they would not have posted their resumes and job interests on any of these resume and job boards. In addition, these approaches are usually limited to external candidates and cannot be used effectively for making internal candidates and their career experiences and visual resume information easily accessible within a company.

Another resume-based approach is disclosed in U.S. Pat. No. 6,266,659 by Nadkarni entitled “Skills Database Management System and Method”. It is an online skills/resume management system that focuses primarily on the skill component of a resume. Because of the narrow focus on skills, the approach is able to develop a relational database that provides a more consistent and structured approach to data capture and search than in the prior arts examples described above and, therefore, addresses some of the deficiencies in the prior art related to the ineffective search due to lack of standard terms in the text based approach. Because the system and method is skills centric its applicability may be limited to those professions and jobs that are heavily focused on skills such as technical professionals. It also does not provide for the visualization of the broader context of a person's career experiences and informal career path and does not extend the relational database approach to all the components of a resume nor provide a visual approach to the resume. It also does not extend beyond the resume to include elements useful in computer aided career self-assessment. It also does not provide for talent analysis of internal and external talent markets leading to high level insights into the informal career paths and patterns within those markets including metrics and measures of career and job mobility.

An example of prior art moving beyond resume-based approaches is disclosed in U.S. Pat. No. 5,978,767 by Chriest et al. entitled “Method and System for Processing Career Development Information.” This approach is an extension of skill management systems and uses skill information from these types of systems as a source and then extracts skill information that can be used by curriculum designers to design new curriculum. Another skills based approach is disclosed in U.S. Pat. No. 6,289,340 by Puram et al. entitled, “Consultant Matching System and Method for Selecting Candidates From a Candidate Pool By Adjusting Skill Values.” This approach is skills centric and is similar to a skill inventory system where users rank their skills according to a specific number scale. It has extended this to allow a requestor to search for a specific skill profile that is adjusted to account for priorities of skills for a particular job such as a consultant. While both of these approaches extend the application of skills management systems beyond their traditional focus on skill inventories for resource management within a firm, it does not help knowledge workers visualize the patterns of skills, roles and knowledge that emerge across their careers so they can clearly identify and articulate their transferable and unique competencies. It does not create insights into the skill needs of professionals when they change careers so the curriculum developed is often valuable only to those professionals who follow traditional career paths and these are decreasing in numbers.

Another example of prior art is disclosed in U.S. Pat. No. 6,070,143 by Barney et al. entitled “System and Method for Analyzing Work Requirements and Linking Human Resource Products to Jobs.” It is related to skills management systems but is more focused on the analysis of job requirements for specific types of jobs. These job requirements include skills but also other attributes of the workers required for these jobs such as their knowledge, abilities and other personal characteristics, This system automates what was in the past a manual approach conducted by job analysts who were typically industrial or organizational psychologists. It is focused on the work and not the worker and therefore provides a valuable description of a job but provides no mechanism for capturing and visualizing the career experiences of the worker that include their informal career path and specific project, role, responsibilities, skills and knowledge in the context of specific jobs the worker held in the past that would be important in determining if there was a fit for the job described. It, therefore, is limited to a job and work centric approach and is not suitable when an organization wants to begin to shift to a worker centric approach and begin to design work around the worker to leverage their unique capabilities and capacity to deliver value. This worker centric approach is emerging in organizations and is often applied first to those critical workers who are most at risk of leaving (i.e. retention risks). The worker centric approach requires more sophisticated career automated career self-assessment methods and systems.

A consistent weakness of the prior art discussed above is the narrow focus and applicability of the systems and methods. They are not multi-purpose and do not meet a broad set of HR needs across talent management, staffing, career development, career management, management and employee development. These HR systems often offer automation of traditional processes in traditional and narrow HR functional areas and therefore do not meet the changing needs of new world of work. Even within a single HR functional area such as career development, a broad set of needs is not being met. for example, career development centers that have emerged inside of companies. They often provide only basic and fragmented self-assessment tools such as the Myers Briggs Personality Type Indicator. Mentoring programs are under-optimized because they lack mechanisms for identifying attractive matches between knowledge workers and mentors. These matches today are accomplished most often by basic one page written profiles, and because there is no automated way to match mentors and mentees, matches are often limited to those that work in common locations. Career management still focuses on traditional vertical career paths within specific disciplines or business functions and these typically are the only career paths visible to employees. HR organizations up to this point have not focused on informal career paths and they still remain for the most part, completely invisible to the company, to HR and to the employee.

As a result of not meeting this broad set of HR needs, organizations are increasingly at risk in losing critical talent. Ironically, the organization even needs to improve the way they measure retention of critical employees. Critical talent retention rates are often currently measured by the retention of those employees with top performance ratings or by tracking “regretted losses” when critical talent leaves the company. As the markets for talent become tighter, the shareholders of a corporation may demand more comprehensive measures and metrics of critical talent retention that go beyond these basic performance or exit interview=based measures. This will require new methods for identifying critical talent by being able to identify high value boundary spanners, effective decision makers, innovators, and those who are highly adaptable to change.

In recognition that traditional HR processes and systems are failing to address the significant and accelerating challenges of today's world of work, companies are beginning to put in place talent management organizations and systems. Talent management is quickly becoming a critical new role and mission of HR and has led to the formation of formal talent management organizations within HR. These new talent management organizations have a distinct strategic role and they also play a critical support role across traditional HR functions such as staffing, management development, and employee development by helping these organizations address the challenges of this new workplace. Talent management organizations need new talent management systems and tools that go beyond the narrow capabilities of current HR systems and move towards more multi-purpose systems that cut across the areas they are responsible for. The emergence of talent management organizations has created a new set of needs that will be met most effectively by a new breed of multi-purpose talent management and career management systems and methods.

Also, since a larger percentage of knowledge workers are now making a living outside of traditional employment arrangements, the capabilities of these talent management and career management systems need to be made available to individuals outside of traditional companies both directly and through intermediaries such as career centers and career coaches. They will need to be made available to academic institutions, and to affinity groups such as the National Society for Engineers, and corporate and academic alumni communities. They will need to be made available to external markets for talent that include local talent markets such as regional economic development councils and more national talent markets through headhunters and executive recruiting firms.

These talent management and career management capabilities will help external talent markets to increase career mobility leading to a more efficient external market for talent. This in turn, will increase the pressures on corporations to create their own efficient internal markets for talent to prevent them from losing their talent to efficient external markets or other companies with efficient internal markets for talent. This competitive cycle will create an accelerated demand for and acceptance of more innovative and multi-purpose talent management and career management systems.

The prior art is not capable of addressing a broad set of needs across HR organizations, individuals (both professionals and pre-professionals), academic institutions, affinity groups, external talent markets such as economic development zones, and of intermediaries in the external talent market such as headhunters, executive recruiters and employment agencies. A multi-purpose talent management and career management system and method is needed that can address these broad set of needs and move beyond the deficiencies of prior art due to the narrow focus and applicability of those systems and methods.

### SUMMARY OF THE INVENTION

An object of the present invention is to provide a multi-purpose talent management and career management system and method that helps organizations attract, develop and retain critical talent through computer aided talent visualization and analysis of the informal career paths of individuals. By informal career path is meant the actual and often unconventional career paths taken by individuals as compared to the prescriptive and highly structured career paths documented by an organization. The present invention is comprised of four major functions:

Career View—for capturing a comprehensive single page two dimensional graphic snapshot of an individual's career experiences and informal career path generated automatically from a set of basic career data.

Visual Resume—for a powerful visual approach to capturing, storing, graphically displaying and communicating an individual's career experiences and traditional resume data. Detailed resume data for each job is hidden behind a graphical job description link that can be easily accessed by clicking on that link. In this manner one can capture a comprehensive Career Autobiography By career autobiography is meant a visual approach to capturing, storing, graphically displaying and communicating comprehensive career data by job. It goes beyond traditional resume data to include data by job, such as strengths, weaknesses, lessons learned, decision factors for taking and leaving a job and the decision stories that that provide context around those factors. Two dimensional views, similar to career view, enable computer aided career self assessment through visualization of patterns of projects, roles, skills and knowledge.

Talent Search—a flexible, multi-search criteria relational data base query capability for searching and viewing career views. The search results display the career area sequence for each career view meeting such criteria and a link to specific career views.

Talent Analysis—a flexible reporting tool that allows for the creation of standard reports on various subsets of career views as determined by a set of search criteria. Standard reports include but are not limited to a career mobility report for displaying career area frequency distributions, a job mobility report for displaying job frequency distributions and a career area starting point report for displaying career area starting point distributions.

The Career View function of the present invention is a single page visual snapshot of an individual's career path. Basic historical career data is input by an individual into a series of simple and quick web-based input screens. A visual history of their career path is automatically generated and displayed as a two dimensional graphical Career View. The look and feel of the Career View can be customized to suit the preferences of the individual. It is also possible to include a link to a video clip or audio file with the Career View so that the Career View owner can provide a short “career story” that encapsulates their career history and experiences.

The Visual Resume function of the present invention is a powerful visual approach to capturing and communicating an individual's career experiences and traditional resume data. Detailed resume data is hidden behind each job displayed in a Career View. This allows the reviewer (e.g. hiring manager) of a Visual Resume to select only the specific jobs where they would like to see detailed resume data. Visual Resume, therefore, enables an individual to include much more information than a traditional resume while at the same time not overwhelming the reviewer with data they do not need to see. Visual Resume provides the valuable context often lost with a traditional resume and it breaks the decades old paradigm of force fitting a career's worth of information into two pages or less.

In addition, a Visual Resume is also powerful computer aided career self assessment system that helps an individual to capture, visualize and reflect on their patterns of career, job, project, and roles experiences as well as the skills and knowledge gained across their career. These are displayed in graphical views similar to the Career View. By visualizing these graphically, they can see patterns emerge over their career history that give them deep insights into their natural talents and help them to clearly identify and articulate their transferable and unique competencies. It goes well beyond traditional resume data to include strengths and weaknesses, lessons learned, and decision for taking and leaving jobs. The result is a comprehensive Career Autobiography that documents an individual's career experiences. This goes well beyond the current skills inventory systems and fragmented self-assessment tools available today.

The present invention provides a set of personalization features for the Career View and Visual Resume functions that allows the individual to specify their desired level of sharing and privacy. Depending on the sharing options they select, their Career Views are made visible on a one-to-many basis to others through the Talent Search function. Alternatively, they can be made available to others on a more one-to-one basis through a “Send Link” function that allows the user to send an email with embedded web links that provide direct access to their Career View, Visual Resume, or Career Autobiography.

The Talent Search function of the present invention provides a capability for searching for and identifying specific types of talent. It includes a powerful and flexible method for searching for and viewing the Career Views of individuals. The Career View data and views are stored in a relational database and made available through an innovative and easy to use web based search screen. The Career Views that meet the search criteria specified are listed with the career sequence for each Career View displayed and with a link to display the full Career View of any particular search result.

The Talent Analysis function of this present invention is a powerful and flexible talent analytics tool that enables an organization to understand the talent dynamics of their organization by analyzing the career and job mobility within an organization. Talent Analysis is used primarily by organizations to analyze the data collected from a large number of individuals across an organization and stored in a relational database during the Career View process. The Talent Analysis screen contains the same search criteria as the Talent Search functions with one additional field used to select the report desired. The present invention contains three types of Talent Analysis reports: a Career Area Report of the number of career areas individuals across the organization have had, a Career Area Starting Point Report of the career area starting points for a selected group of individuals across the organization, and a Jobs Report of the number of jobs individuals across the organization have had.

The object of the present invention discussed above, enables organizations to address the talent related issues and deficiencies in prior art described in the previous section. They will enable talent management organizations, in their strategic role, to be better able to attract, develop and retain critical talent and to help optimize the performance of the talent across the company. It will help them leverage a common set of capabilities for multiple purposes across talent management, staffing, management development and career development.

Talent management capabilities enabled by the present invention include:

The ability to visualize and analyze patterns of informal career paths and mobility across the organization in ways not possible before since informal career paths are often invisible to the organization.

The ability to develop and demonstrate career mobility as a key component of their employer value proposition.

The ability to understand talent in their organization as a talent market and to measure the efficiency of that internal talent market by measuring the movement or career or job mobility within the organization.

The ability to provide talent-brokering capabilities that help connect buyers (i.e. hiring managers) and sellers (i.e. the employees) of talent within the organization, and that more effectively connect mentors with mentees.

Staffing capabilities include:

The ability to enhance and differentiate the organization's on-line recruiting capability by allowing candidates to view the informal career paths of those within the organization through access to selected Career Views or the Talent Search function. Candidates will be better able to understand the long-term career options open to them within the organization. They will also be better able to make more informed career starting point decisions by self selecting into a better matching first job that can help increase retention rates during the critical first two years on board with the organization.

The ability of the staffing organization to use Talent Search to identify passive job seekers and also to act as talent broker in connecting candidates with appropriate employee career advisors.

These capabilities can provide a significant competitive advantage to the company in its effort to recruit top talent.

Management development capabilities include:

The ability of management development to more effectively enable the role of manager as coach in the organization by providing the ability for managers to visualize and better understand the career experiences of their employees. Managers can be better able to coach employees by understanding additional career options that may be open to the employee. The career path visualization and computer aided self-assessment capabilities can help the manager to coach the employee through the career self-assessment process.

The ability to more effectively delegate based on roles that are natural to some and not to others. These patterns of natural roles are surfaced using the computer aided self-assessment capabilities of Visual Resume and Career Autobiography.

The ability to move beyond performance ratings as the primary measure of critical talent by incorporating measures of diverse career experiences that can point to individuals that are more effective decision makers, more innovative and more capable of spanning difficult organizational boundaries.

The ability to better recognize retention risks by identifying those employees that have already demonstrated a willingness to move between jobs and careers within the organization and thus are more likely to leave an organization.

The ability to help managers become more aware of the talent dynamics of the internal talent marketplace and that an efficient talent market is dependent on movement or career and job mobility. Providing managers with mobility metrics and examples of informal career paths can help them see the significant benefits associated with increased career and job mobility. This can help the organization decrease the number of managers who are inhibitors to enabling career mobility across a company.

Career development capabilities include:

The ability to move beyond more traditional “career ladder” based career paths to include the informal career paths that actually exist in an organization.

The ability of employees to find better matches with mentors across the organization that have informal career paths aligned with the interests of the mentee.

The ability of employees to expand the career options open to them and the ability to find career and job opportunities by viewing the Career Views of other employees or by connecting to informal career advisors or HR talent brokers.

The ability of employees through the computer aided self-assessment functions of Visual Resume and Career Autobiography to develop the deep self-knowledge required to more effectively design work and career options that are aligned with their natural talents and interest.

Additional objects of the present invention go beyond the organizational HR applications described above to include academic institutions, affinity groups (e.g. Professional Associations, corporate and academic alumni communities), regional economic development councils, headhunters and executive recruiting firms, career centers and career coaches, and individuals themselves (professionals and pre-professionals).

Academic institutions capabilities include:

The improved ability to recruit high potential high school students or advanced degree candidates by displaying various Career Views of successful alumni of particular degree programs of the institution.

The ability of faculty to adjust their curriculum to include the career needs of students by viewing the typical informal career paths of specific degree programs and analysis of their career starting points and mobility patterns.

The ability of the academic institution to offer more targeted executive and continuing education offerings since they will know the current career and job areas of their alumni.

Affinity group (e.g. professional associations, corporate and academic alumni communities) capabilities include:

The ability for certain associations and societies to attract desirable professionals. For example, the National Society for Engineers could use various Career Views of successful engineers to attract more high school students into the engineering profession. As the war for talent accelerates, other talent-starved professions can do the same (e.g. Nursing).

The ability of the professional associations and corporate and academic alumni to stay better connected to their constituencies and to increase the career opportunities open to their members by providing better connections with corporate recruiters and headhunters through the Talent Search function.

The ability to analyze the career and mobility patterns of those within their affinity group.

Regional economic development council abilities include:

The ability to attract new companies to an economic development zone by making local talent visible without sacrificing the anonymity of the individuals. As more companies are attracted to an area, more movement between companies can occur, leading to a more efficient local market for talent that can then attract additional companies leading to significant economic growth for an area.

The ability, through Talent Analysis, to analyze workforce profiles within industries, workforce vitality (e.g. demographics), workforce mobility, workforce critical talent attraction and retention, workforce entrepreneurship, workforce executive talent pool, and workforce concentration of competencies.

Headhunters, executive recruiters and employment agencies can use Talent Search capabilities to find passive job seekers, and they, along with career coaches and career centers, can use the computer aided self-assessment capabilities of Visual Resume and Career Autobiography to help their clients manage their careers more effectively and to make them more attractive and distinctive in the job market. Individuals, independent of any of the above organizations, can create their own Career View and Visual Resume to help make themselves more visible in external talent markets without sacrificing their anonymity. They can also use the Visual Resume/Career Autobiography function for career self-assessment to better understand and articulate their natural talents and competencies. They can use Talent Search to understand what career options might be open to them as they browse Career View of others with similar backgrounds but with different career paths.

All of the objects of the present invention included above address the many deficiencies in prior art discussed in the section “Description of the Prior Art”.

### BRIEF DESCRIPTION OF THE DRAWINGS

For a more complete understanding of the present invention, reference is now made to the following descriptions taken in conjunction with the accompanying drawings, in which:

FIG. 1 is a high level diagram that outlines the talent and career management system functions in order to provide a logic and structure for follow-on figures.

Data Capture:

FIGS. 2A-2C are the present embodiment of the web based data input fields for developing a Career View. They capture general information, education information about college degrees and basic information about each job.

FIG. 2D is the present embodiment of the customization options for a Career View.

FIGS. 3A-3H is the present embodiment of the web based input screens for developing a Visual Resume and Career Autobiography.

FIG. 31 is the present embodiment of the Display Controls that allow the user to determine which data fields to include in their Visual Resume.

Common Services:

FIG. 4A is the present embodiment of the Career View Privacy Controls, General Controls and the Media Link function for attaching video and/or audio links to a Career View.

FIG. 4B is the present embodiment of the sharing controls via the Send Link function that allows a user to send an email with links to the user's Career View, Visual Resume or Career Autobiography views.

Database Drawing:

FIG. 5 is a high level diagram of the relational database design for all the data stored and retrieved through the other functions described.

Individual Graphical Views and Reports:

FIGS. 6A-6E represent the two-dimensional graphical views of a person's historical career path. FIG. 6A represents the Career View that is used to visualize a person's informal career path. It is also the view used as a “graphical front cover” and “graphical link menu” for the Visual Resume and Career Autobiography. FIGS. 6B-6E represent the Career Autobiography views that include FIG. 6B—Project View, FIG. 6C—Role View, FIG. 6D—Skill View, and FIG. 6E—Knowledge View.

FIGS. 7A-7B represent the reports that are available that provide the detailed historical information over that person's career. FIG. 7A represents the Visual Resume report that includes detailed resume data, while FIG. 7B—represents the Career Autobiography report that includes the complete set of data entered during the data capture process.

Database Queries and Reports—Talent Search:

FIG. 8A is the present embodiment of the web based Talent Search database query screen where a user specifies the search criteria for the types of Career Views they are looking for.

FIG. 8B is an example of a Talent Search Report that might result from a specific query as is made using the Talent Search screen in FIG. 8A. It results in a list of Career Views that meet the search criteria and includes links in order to view the full Career View of each listing resulting in a view similar to that represented by FIG. 6A.

Database Queries and Reports—Talent Analysis:

FIG. 9A is the present embodiment of the web based Talent Analysis where a user specifies the report criteria for a specific type of Talent Analysis to conduct on the selected subset of Career View data in the relational database.

FIGS. 9B-9D are examples of three different types of reports that can be generated in the present embodiment of this invention.

System Administration:

FIGS. 10A-10O is the present embodiment of the web based System Administration functions available to setup and manage the entire set up functions described earlier.

### DETAILED DESCRIPTION OF INVENTION

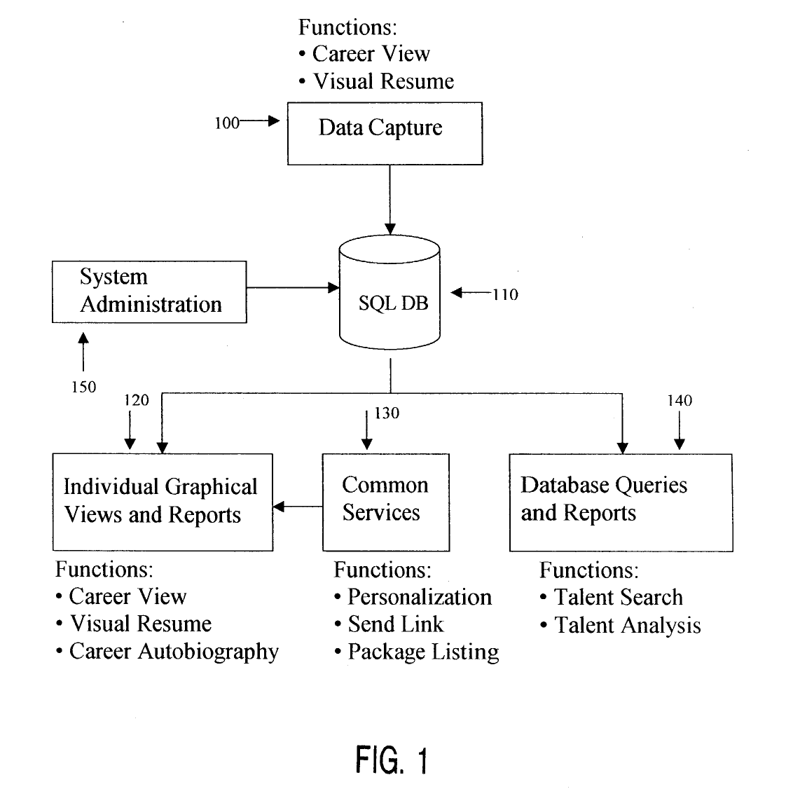

FIG. 1 is a diagram that outlines the talent and career management system functions in order to provide a logic and structure for follow-on figures. Data is captured 100 through Career View and Visual Resume input screens. Data is stored in a relational database 110 and then is used to generate individual graphical views and reports 120 that include the Career View, Visual Resume and Career Autobiography. Common Services 130 are provided to allow users to customize the privacy options for their Career Views and to allow them to share their individual graphical views and reports 120 directly with others via an email with embedded links. Database queries and reports 140 are possible across the Career View data stored in the relational database for large numbers of individuals using the Talent Search and Talent Analysis functions. The system is managed using a comprehensive set of System Administration 150 functions that allow the Site Administrator to set up and configure the system and monitor and report on usage.

The technology implementation of the present invention is entirely web based. It utilizes Cold Fusion by Macromedia for all business logic (screen design and navigation). The relational database 110 is implemented with Microsoft's SQL Server, with connections to the database implemented using Open Database Connectivity (ODBC) which is a widely accepted application programming interface (API) for database access. This design will allow various database technologies (e.g. IBM's DB2) to be snapped in as an alternative to Microsoft's SQL Server depending on customer requirements. Application execution utilizes Java technology including Java Beans and Java Server Pages (JSP) in order to improve the performance of the system.

Data Capture:

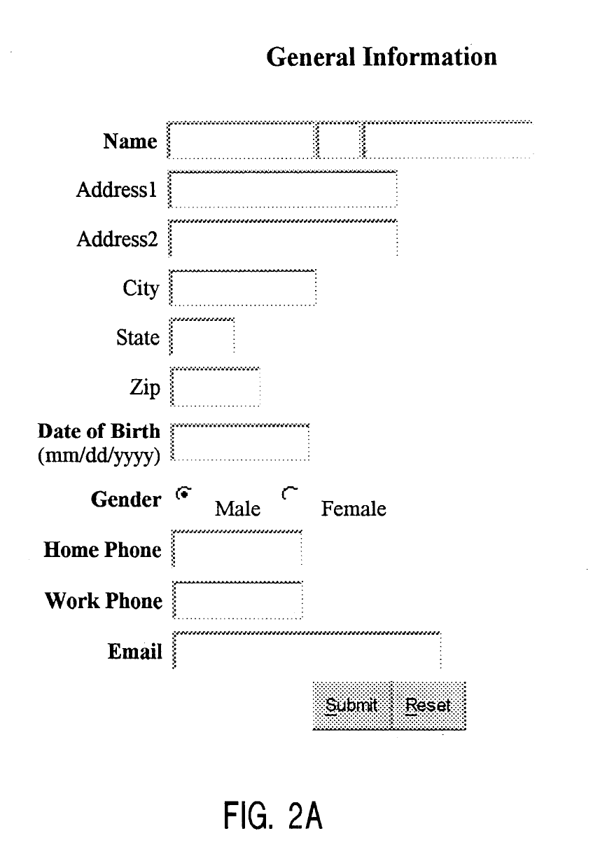

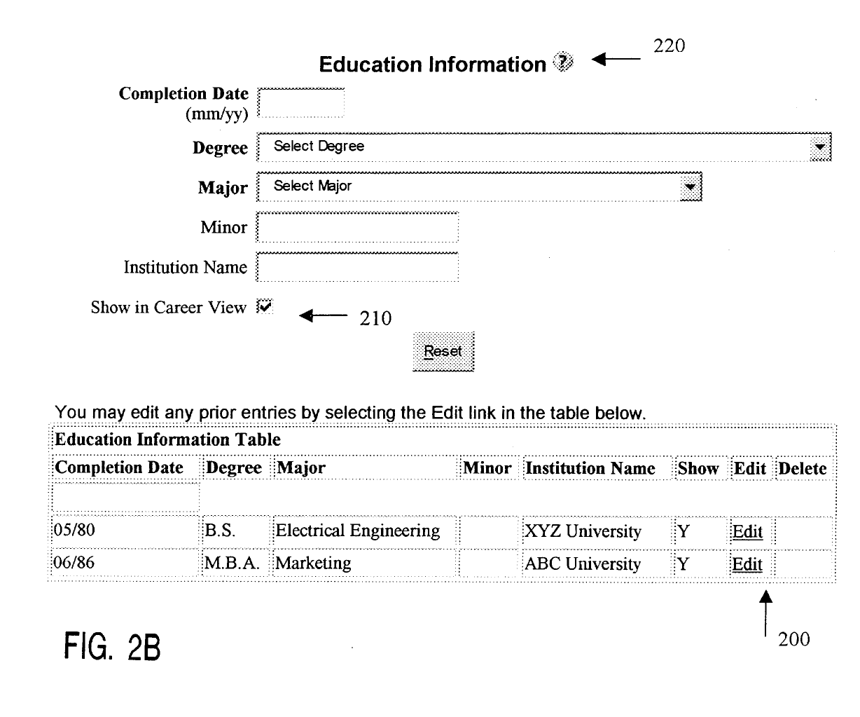

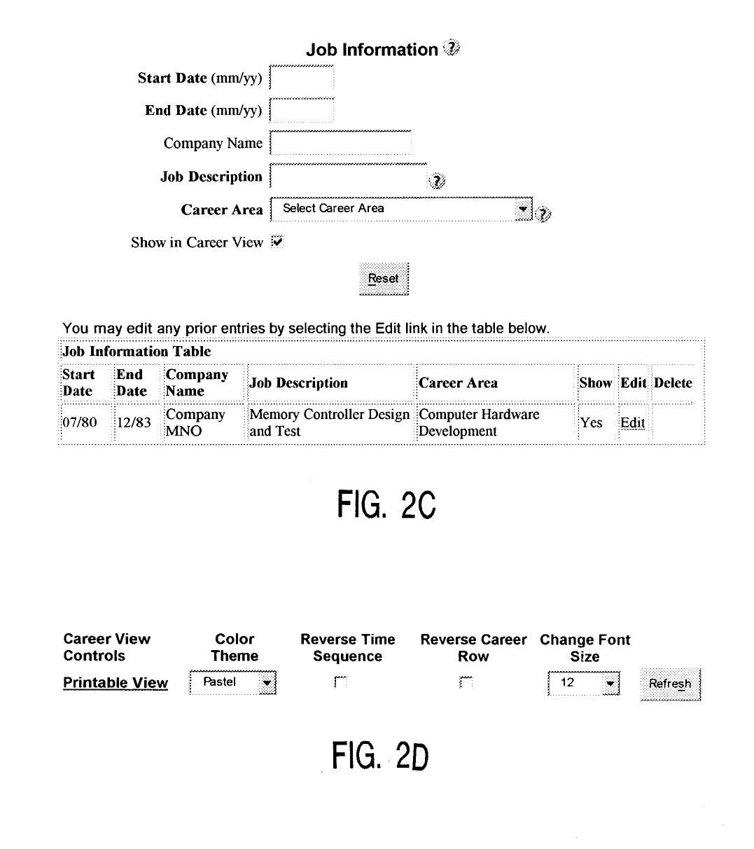

FIGS. 2A-2C are the present embodiment of the web based data input fields for developing a Career View. They capture general information, education information about college degrees and basic information about each job. FIG. 2A captures General Information about the user that is not already captured during the registration process. Data captured during registration is automatically displayed to avoid having to re-enter the data. Date of Birth is used as an identifier during the password reset process if a user forgets their password. Gender is a field used in Talent Search that allows the user to search on only men or women or both. All bold inputs fields are mandatory (this applies to all input screens). FIG. 2B is the Education Information about the college degrees and majors a person has achieved. They enter the completion date of the degree and select the degree and major from the drop down lists provided. They can optionally enter a minor and the institution name. Each degree entered is saved and displayed in the Education Information table and can be edited or deleted at any time through the Edit or Delete buttons 200 in that table. There is also a button 210 they can check to allow this information to be displayed in their Career View. There is a question mark button 220 that can be selected at any time for additional help. These help buttons are used throughout the system to provide help at a screen level and input field level. FIG. 2C is used to capture the data about each job a person has had in their career history. Data collected includes start and stop dates for the job, the company name, a short job description (50 characters or less) and a selection of an appropriate Career Area from the drop down menu provided. Each job description entered is saved and displayed in the Job Information table and can be edited or deleted at any time through the Edit or Delete buttons in that table. There is also a button they can check to allow the specific job to be displayed in their Career View. The data input in these screens (FIGS. 2A-2C) is the data available in the present embodiment for the creation of the Career View and the source of relational data for the Talent Search and Talent Analysis functions. It typically takes a user only 15-20 minutes to complete these input fields.

FIG. 2D is the present embodiment of the customization options for a Career View. The default Career View starts with the oldest job in the upper left corner and moves down to the lower right with the most current job. The rows of the Career View representing the Career Areas can be reversed as can the time sequence (or columns) which results in the oldest job in the lower left corner and moving to the upper right, corner for the most recent job. The font size of the text can be changed. This is often not necessary unless the Career View contains a large number of jobs that would not fit on one printed page. The user can select from different color themes using the drop down Color Theme menu. There is a different color used for each Career Area to distinguish the different careers a person has had experience in. There is a selection for a Printable View that pops up a new web screen with a Career View that is formatted for print.

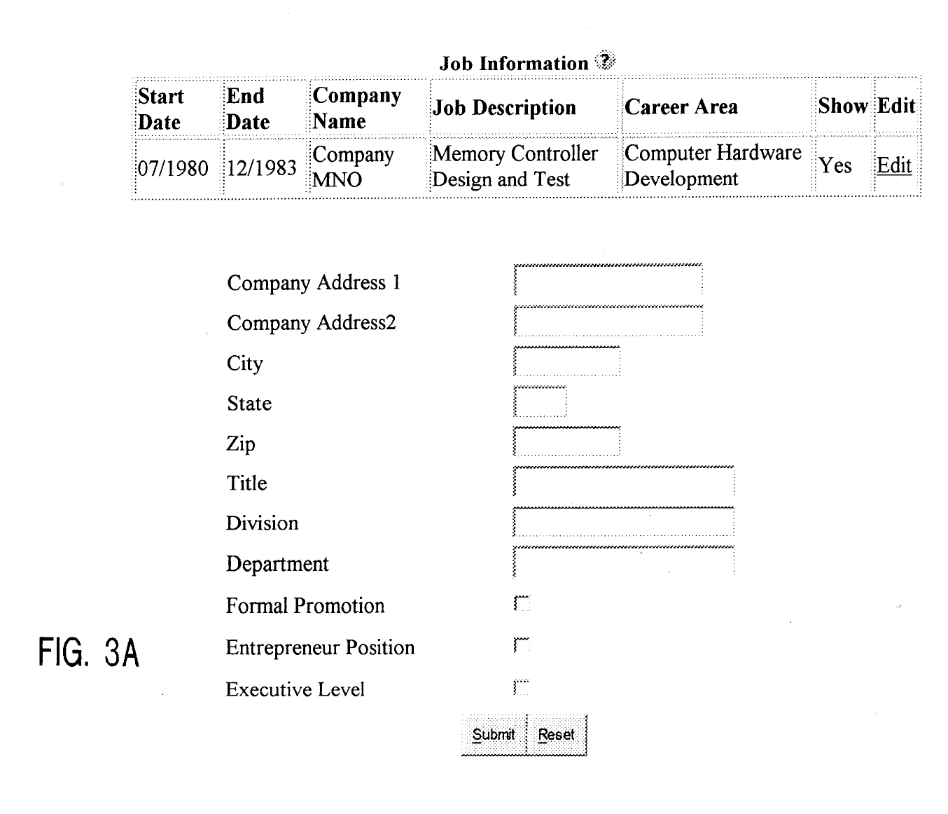

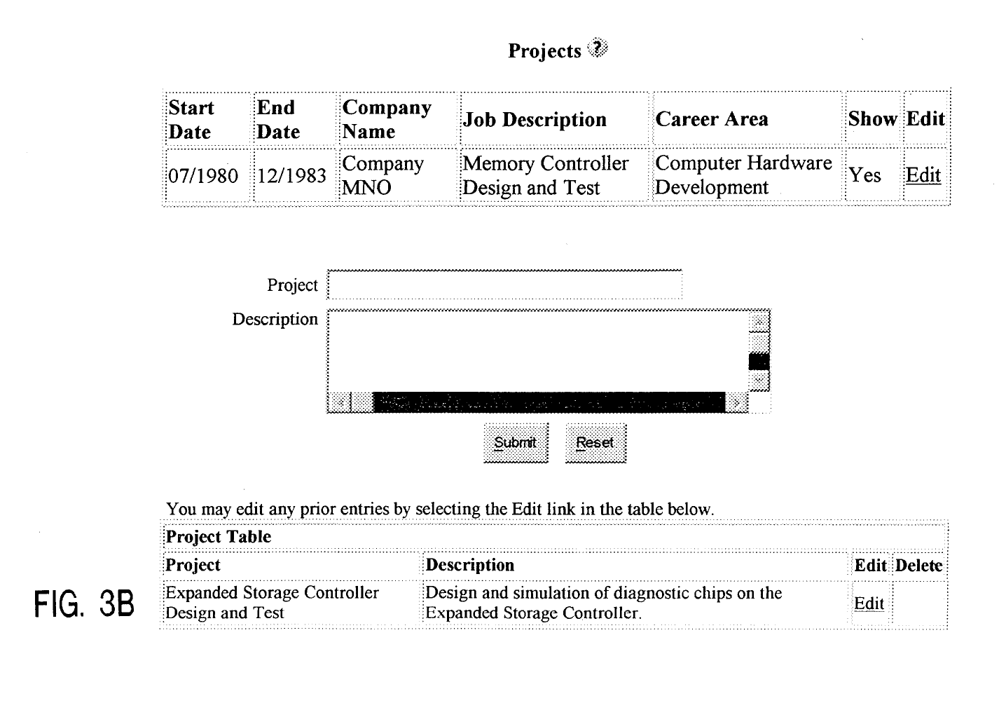

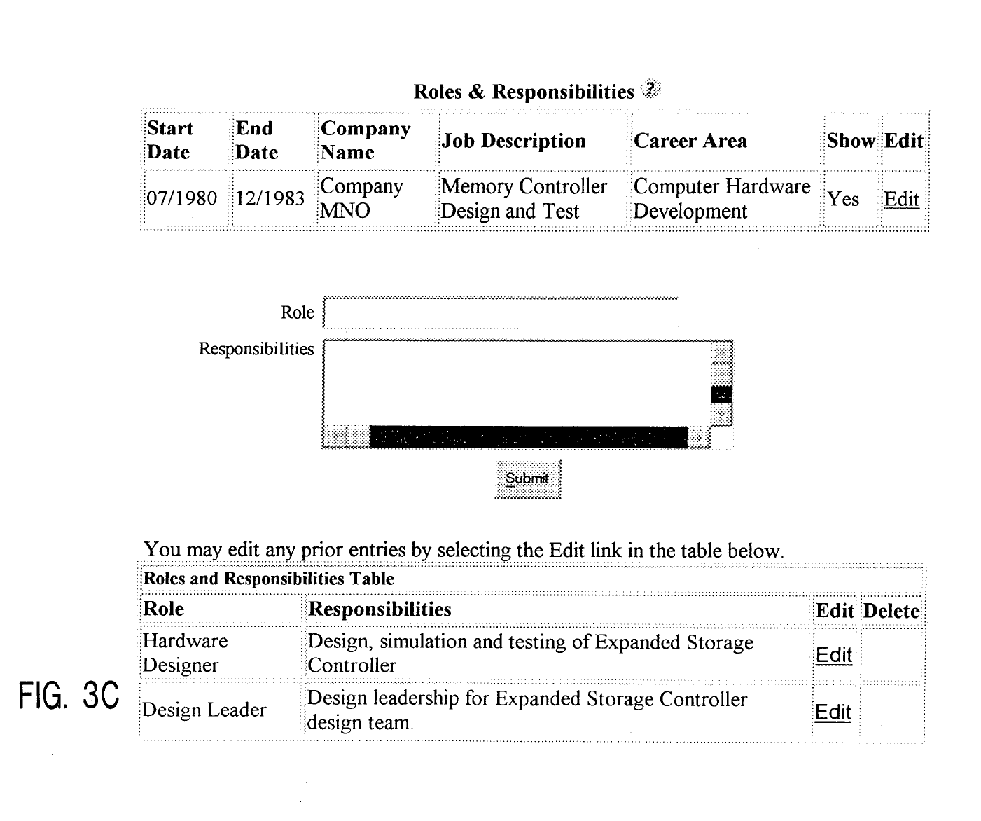

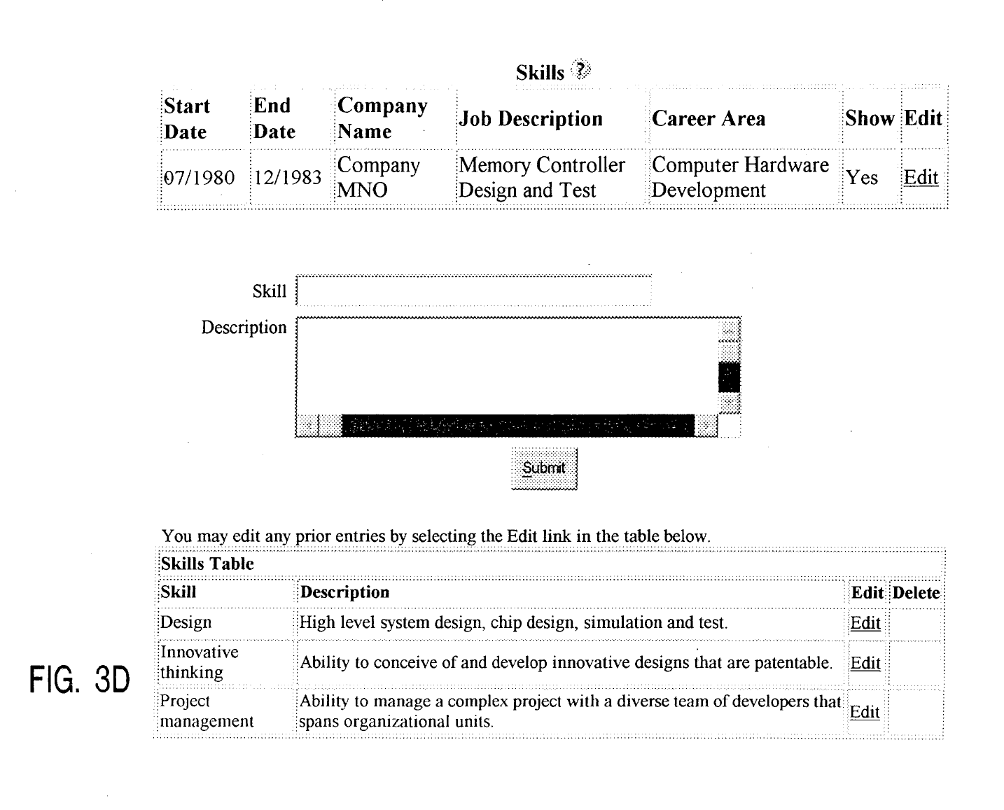

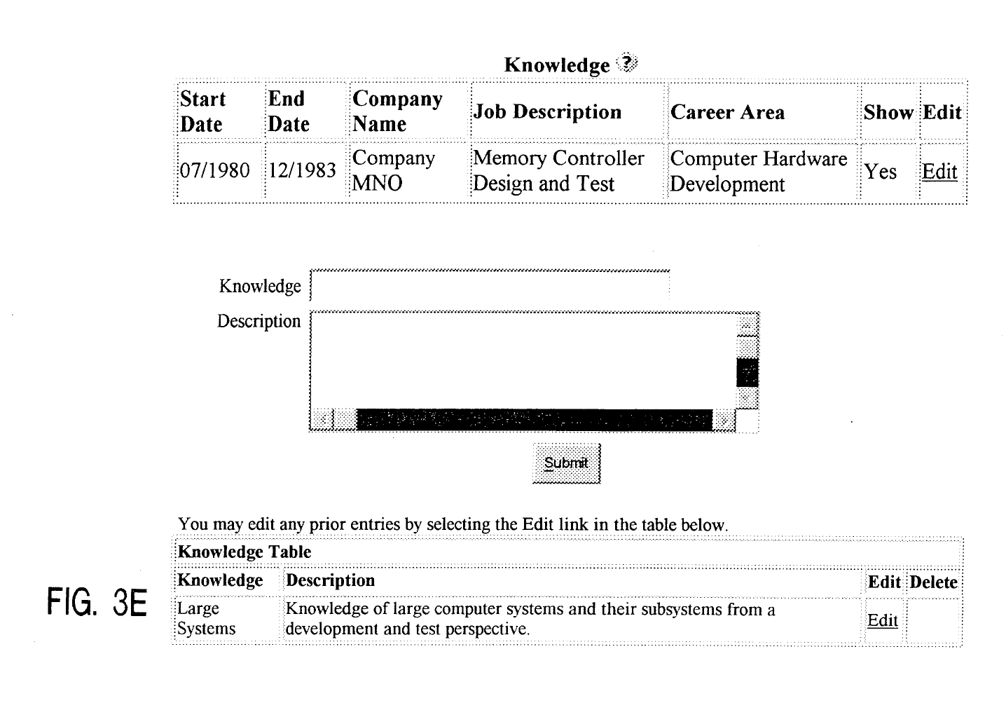

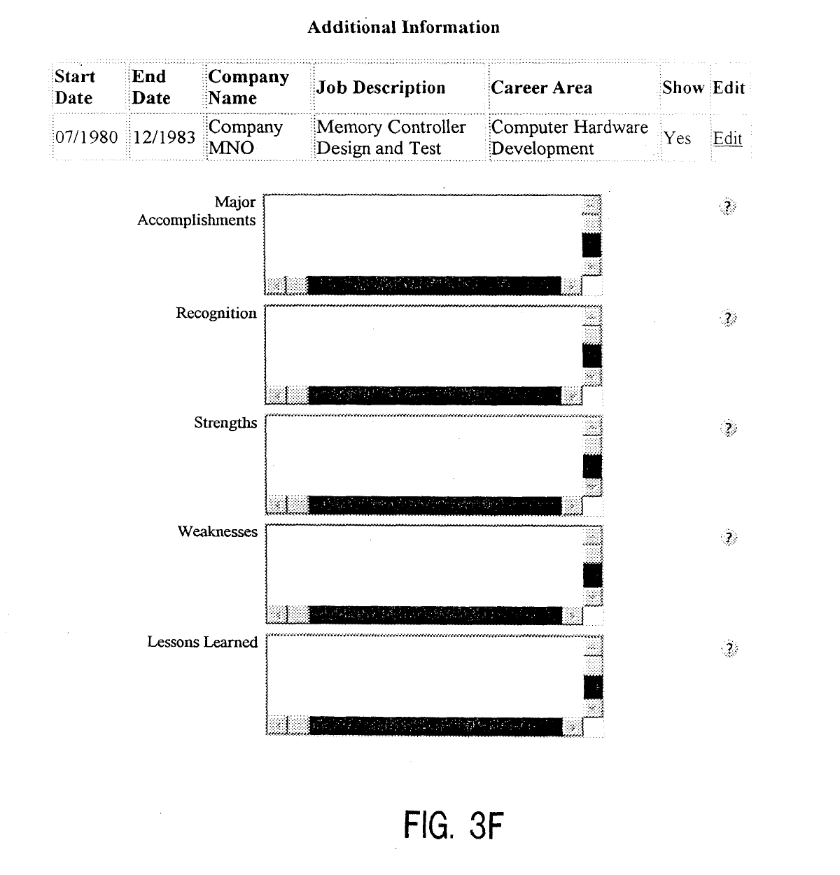

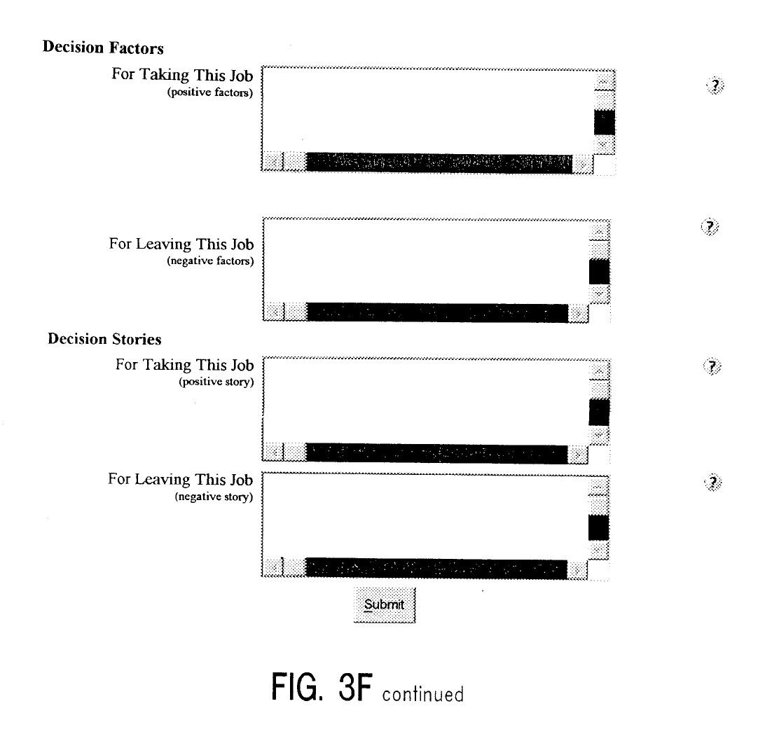

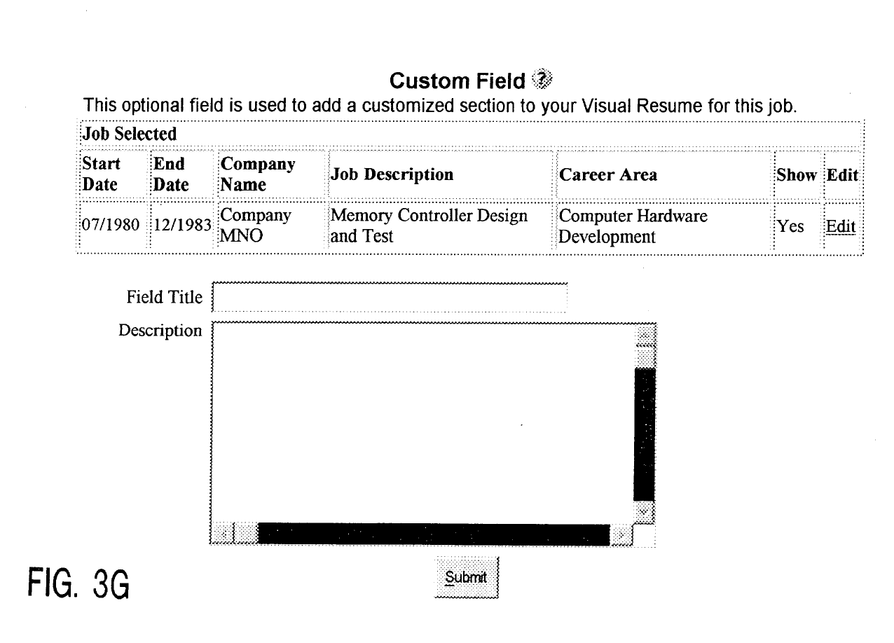

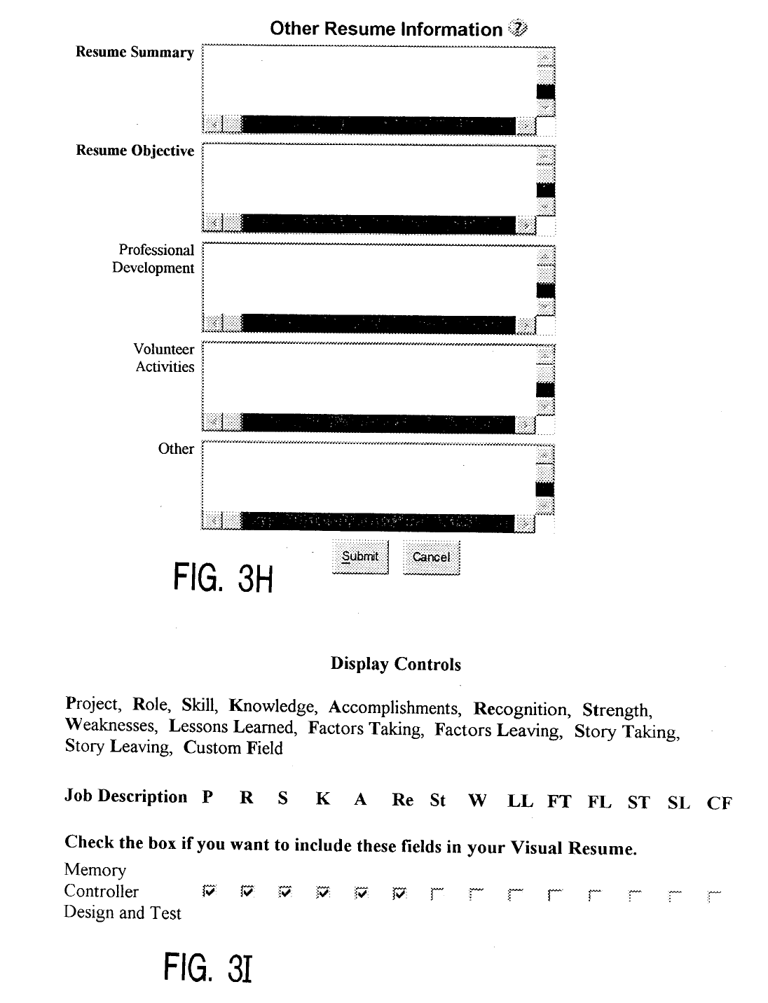

FIG. 3A-3H is the present embodiment of the web based input screens for developing a Visual Resume and Career Autobiography. FIGS. 3A-3G capture information for one job at a time and a user will typically complete the data entry in FIGS. 3A-3G for one job and then repeat the process for each subsequent job. FIG. 3A captures general Job Information for the specific job listed in the table at the top of the screen. FIG. 3B captures the project experiences for that job, FIG. 3C—the roles and responsibilities, FIG. 3D—the critical skills acquired, FIG. 3E—the critical knowledge acquired. Each entry is displayed in an Information Table at the bottom of the screen that allows the user to edit or delete an entry at any point. FIG. 3F captures Additional Information for the job. The Major Accomplishments and Recognition fields are often included in a Visual Resume while the other fields are not normally displayed in a Visual Resume but are included in the comprehensive Career Autobiography for career self-assessment purposes. This more personal Career Autobiography information includes strengths, weaknesses, lessons learned, decision factors for leaving and taking a job and the stories that put context around those decisions. FIG. 3G is an optional screen that allows the user to customize their Visual Resume by adding a Custom Field for each specific job. For example, an author may want to list Citations or an inventor may want to list patents filed. FIG. 3H captures more general resume information (Other Resume Information) that is not tied to any specific job. This includes traditional resume fields such as Resume Summary, Resume Objective, and optional fields such as Professional Development, Volunteer activities and a field for Other that allows the user a degree of customization of the information included there.

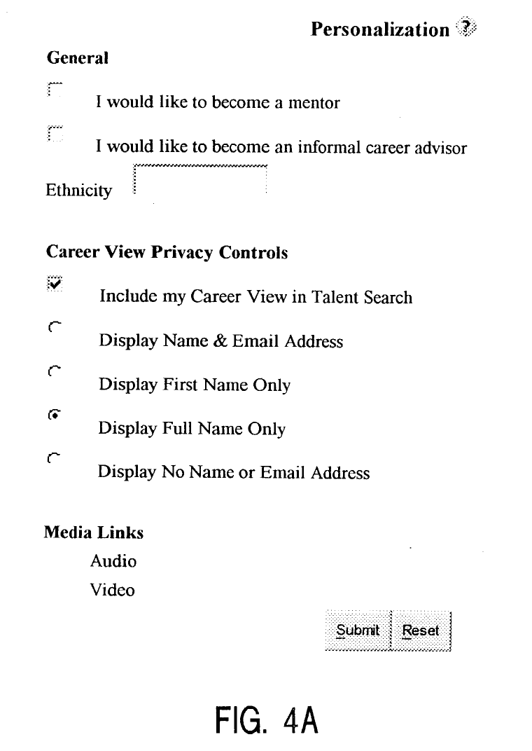

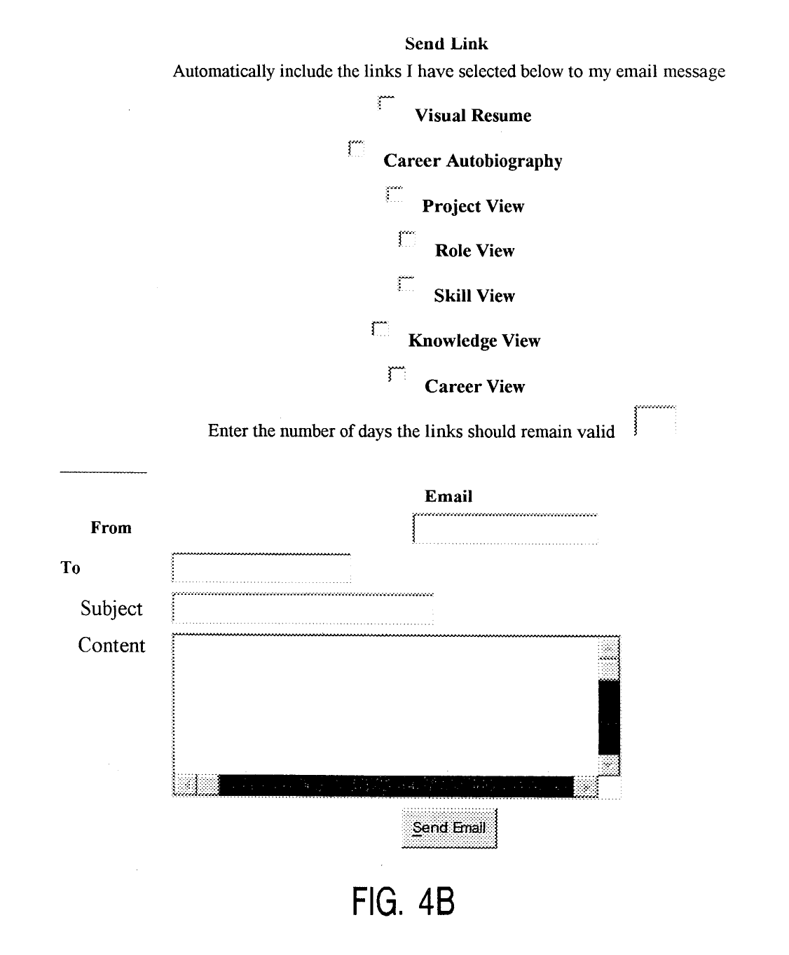

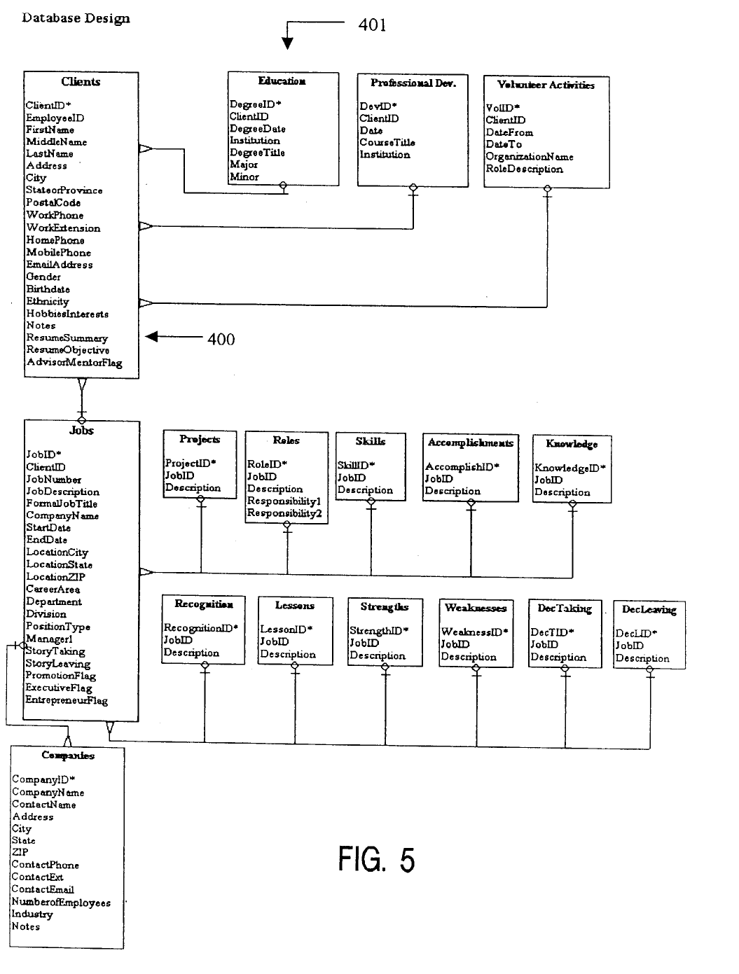

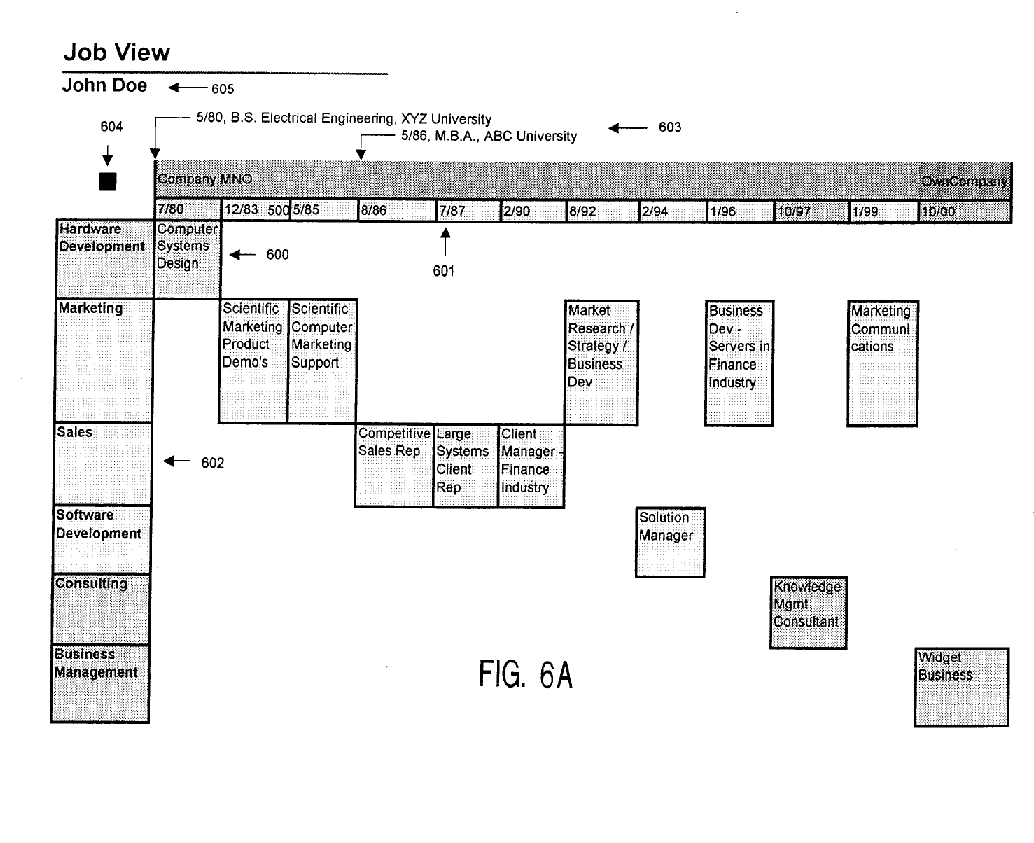

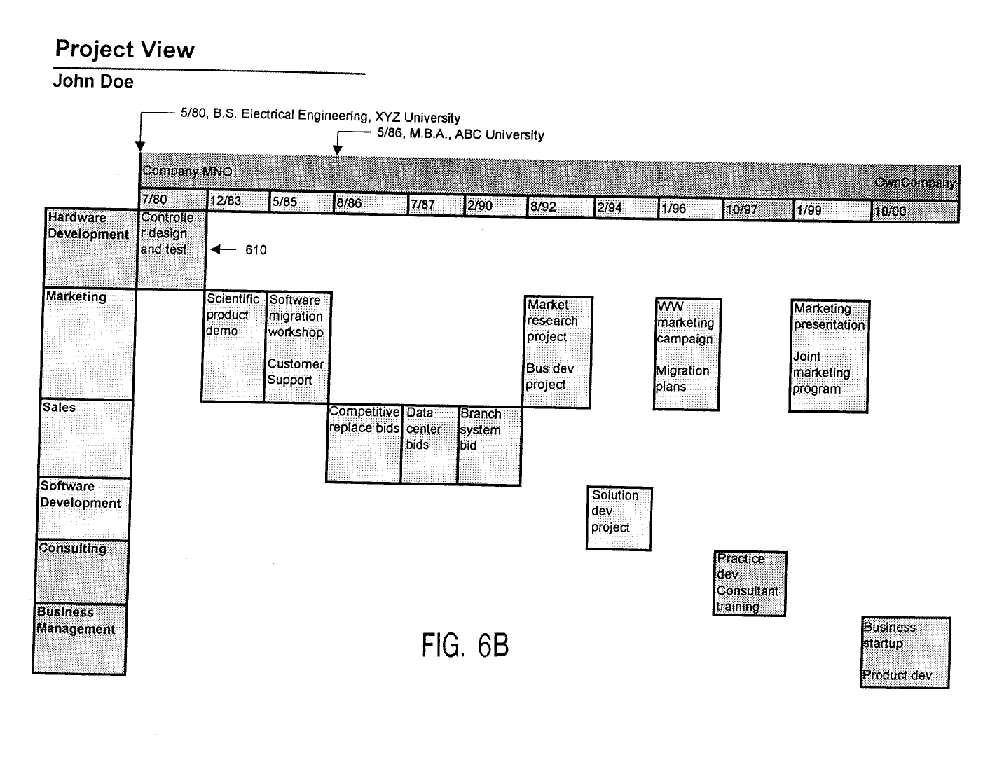

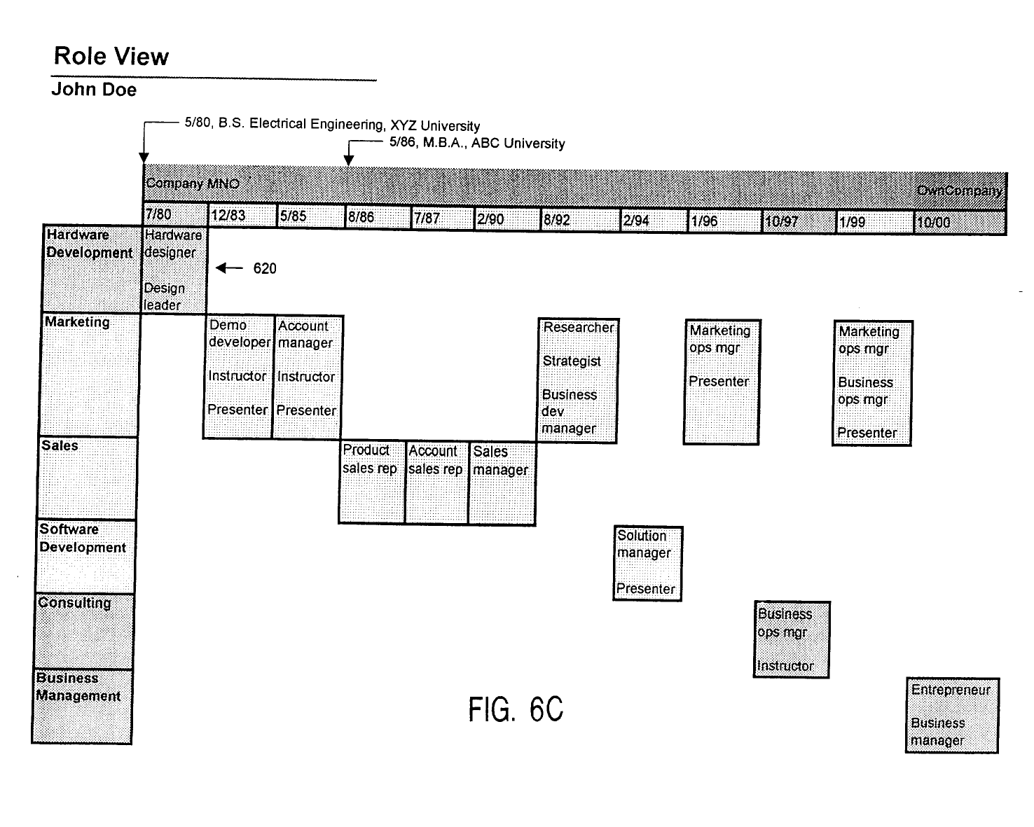

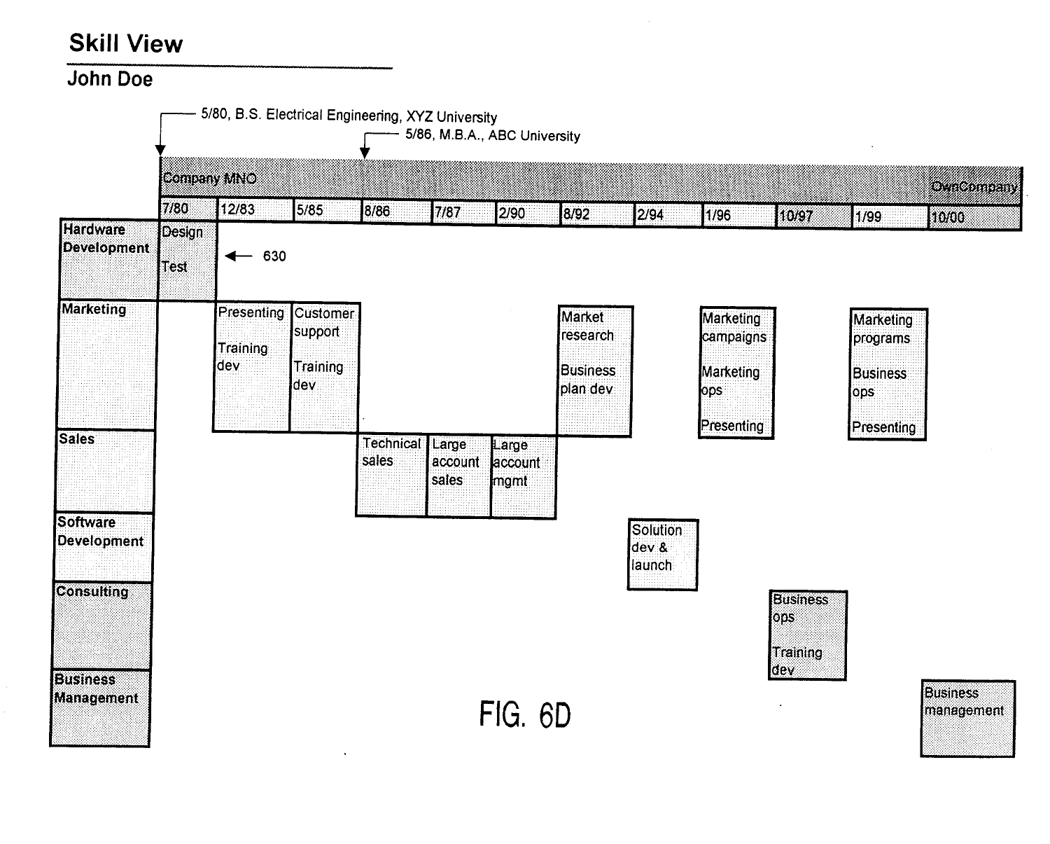

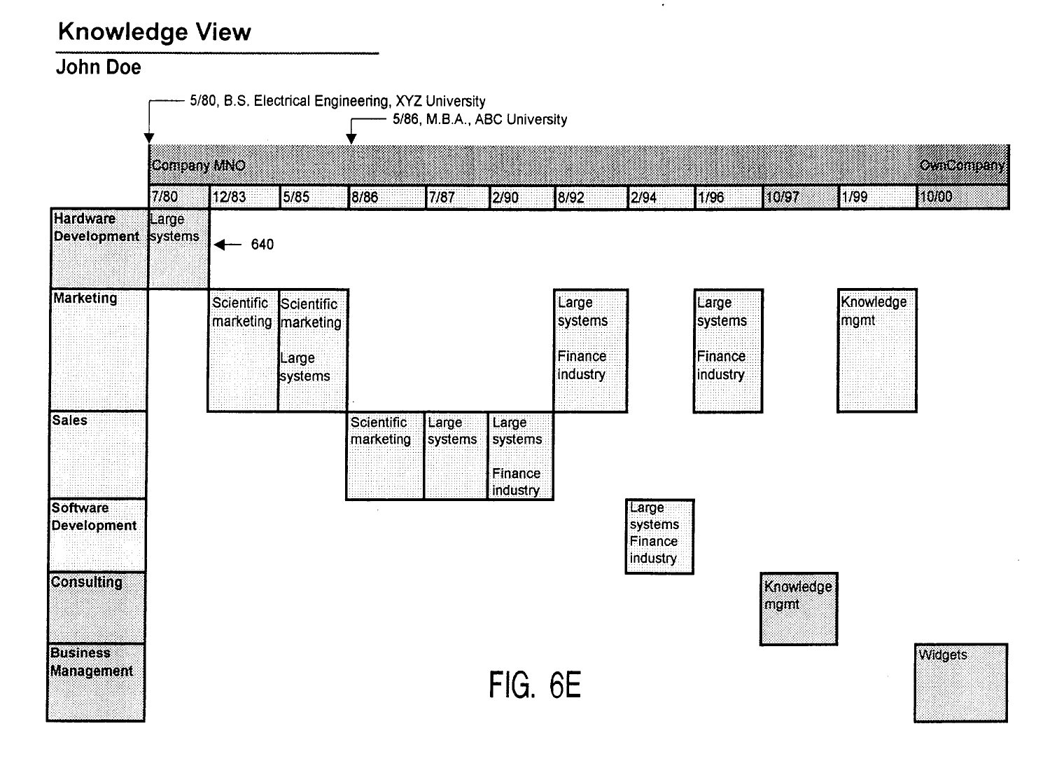

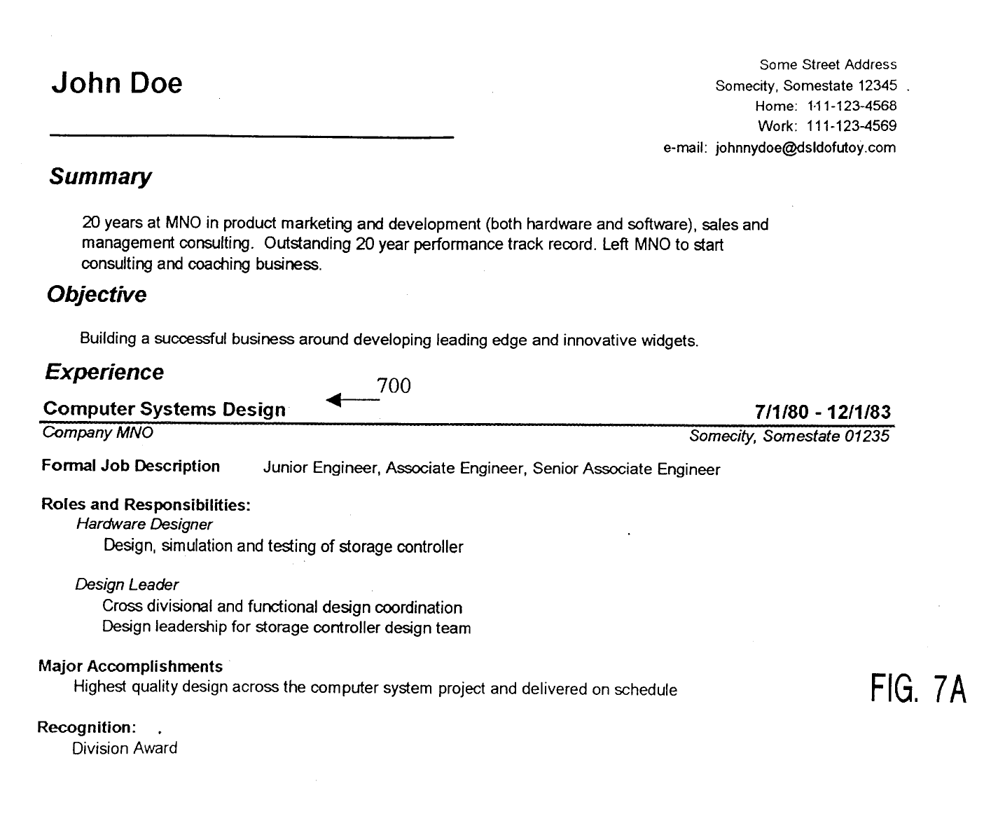

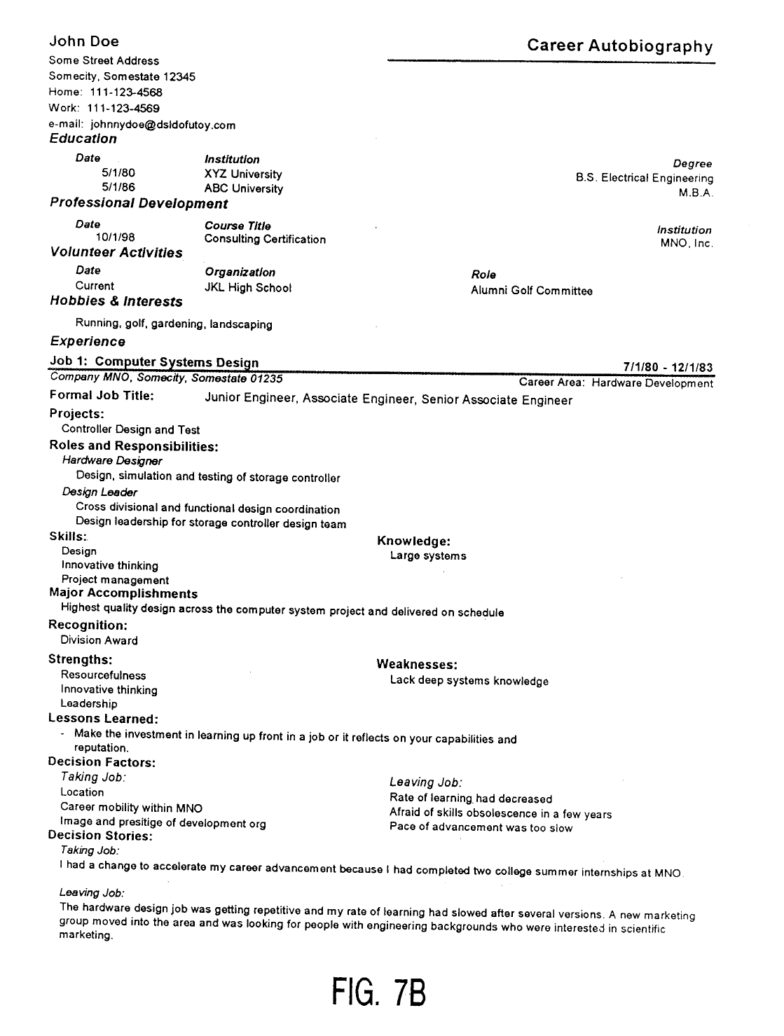

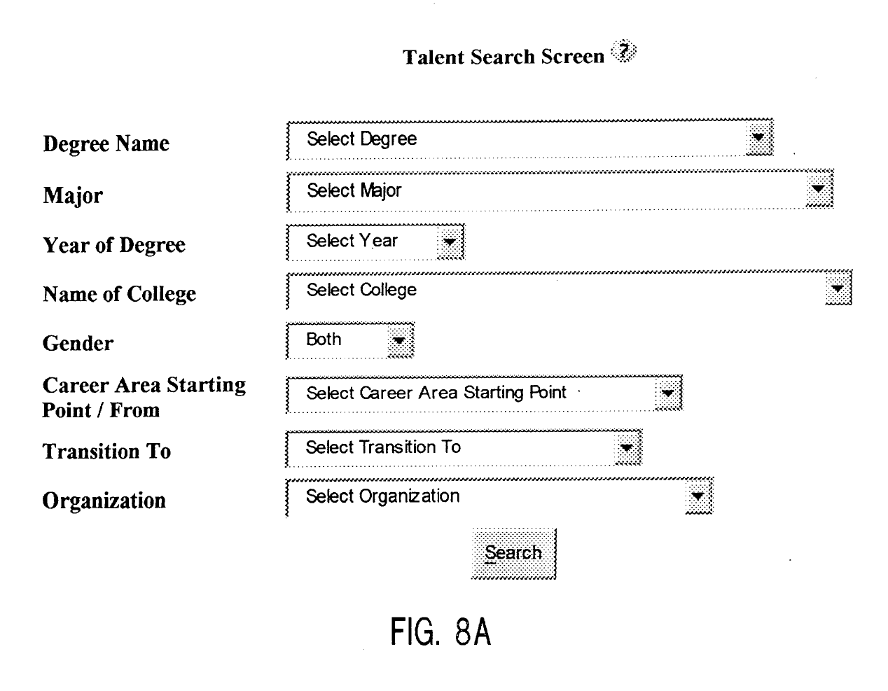

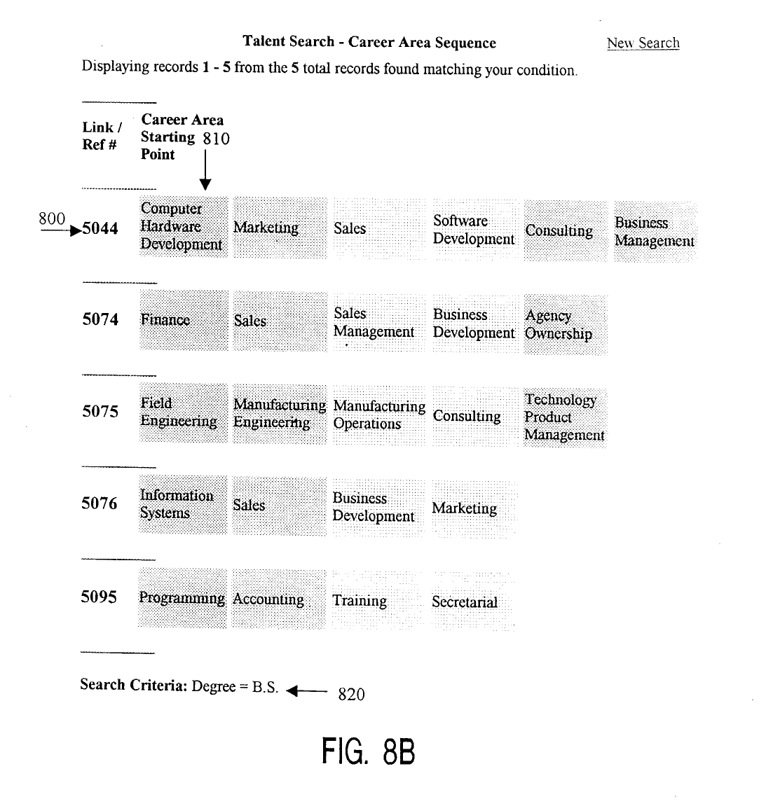

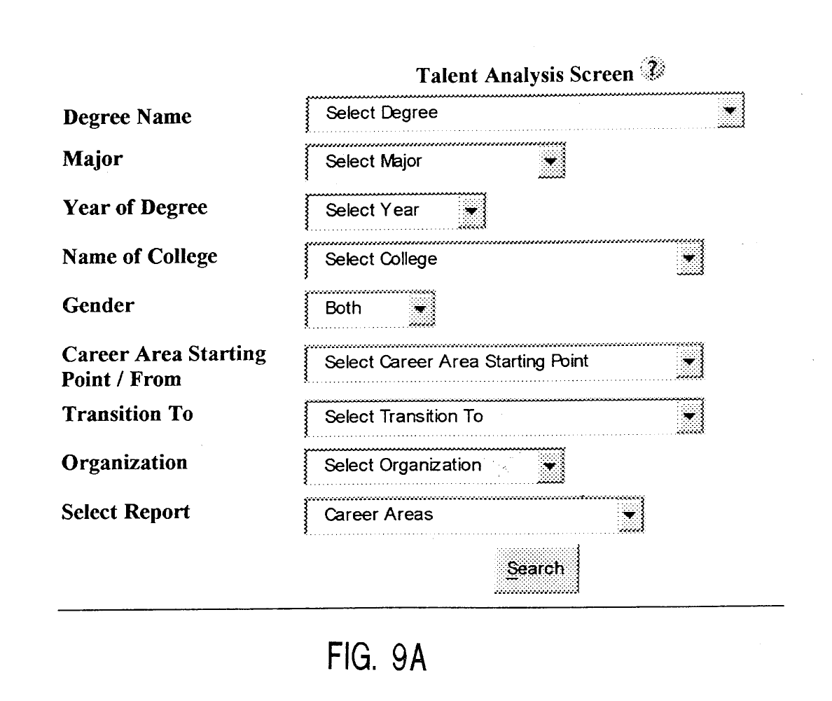

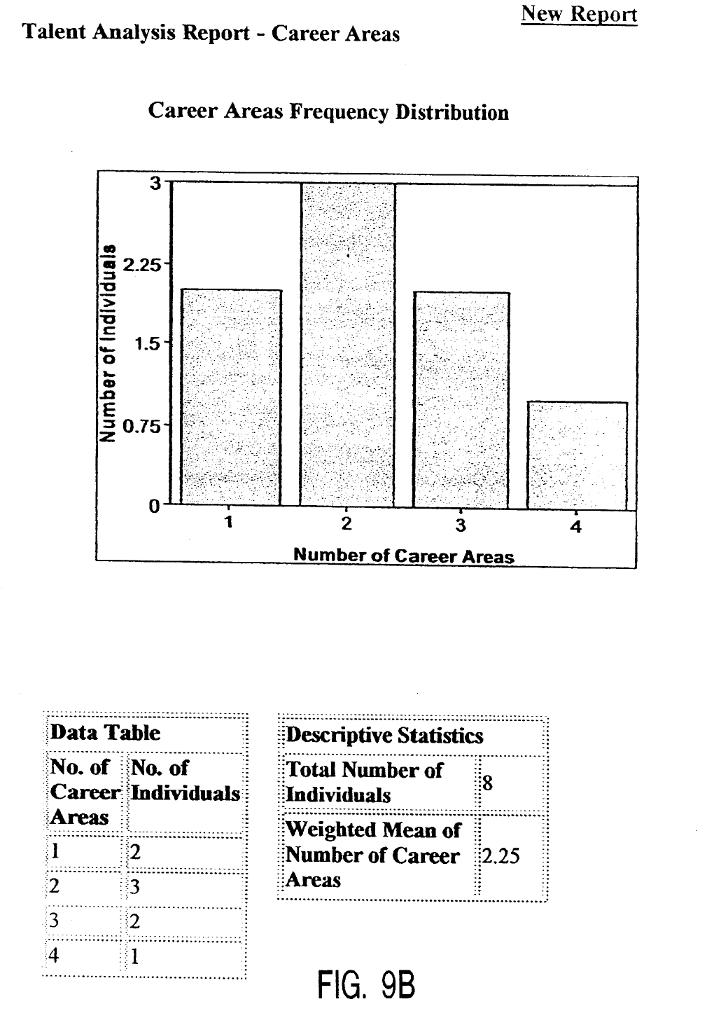

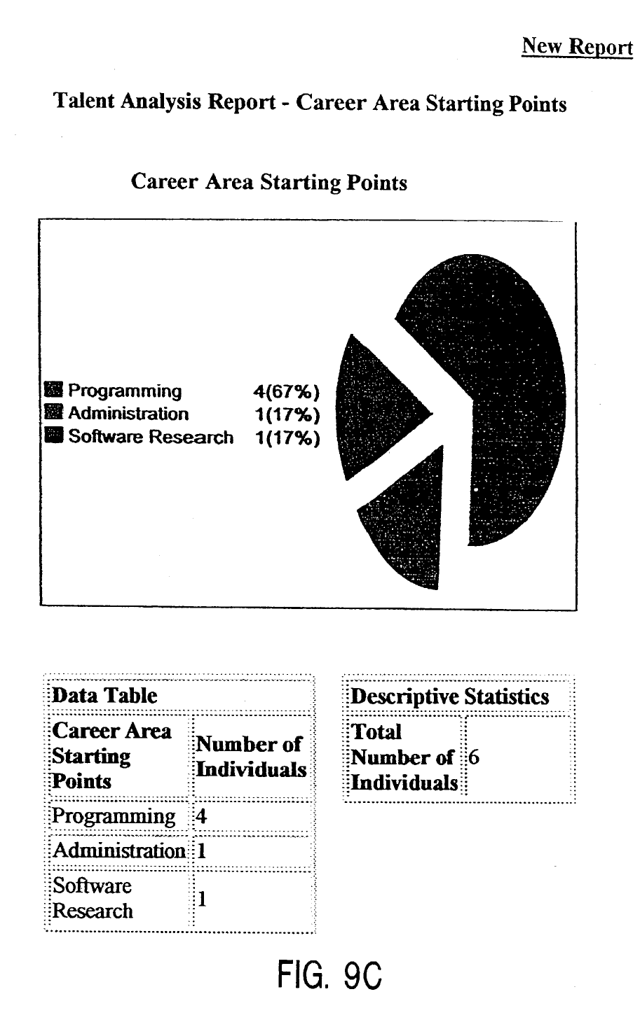

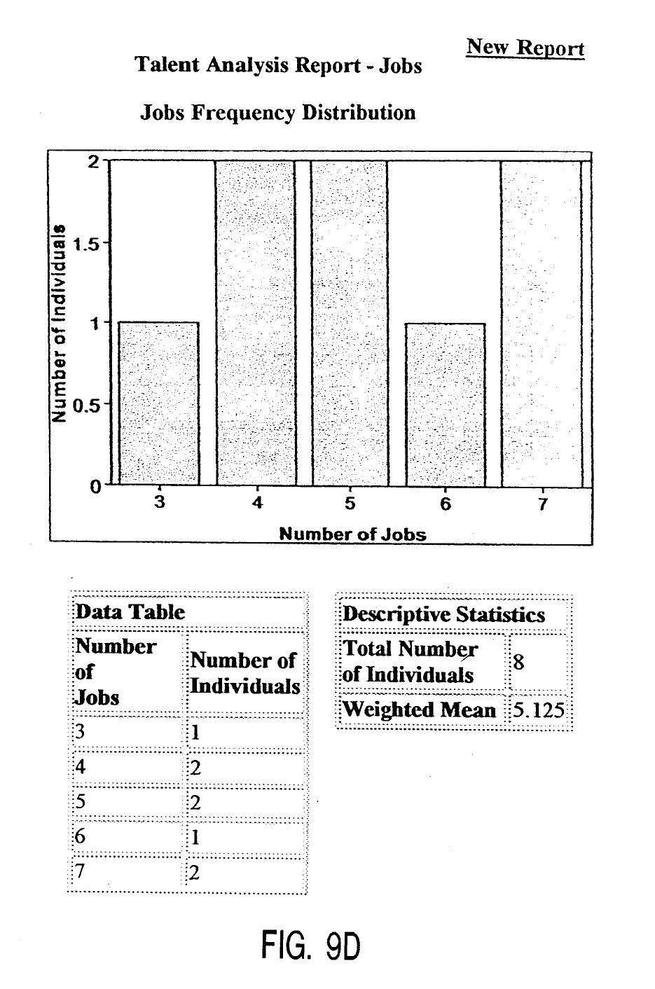

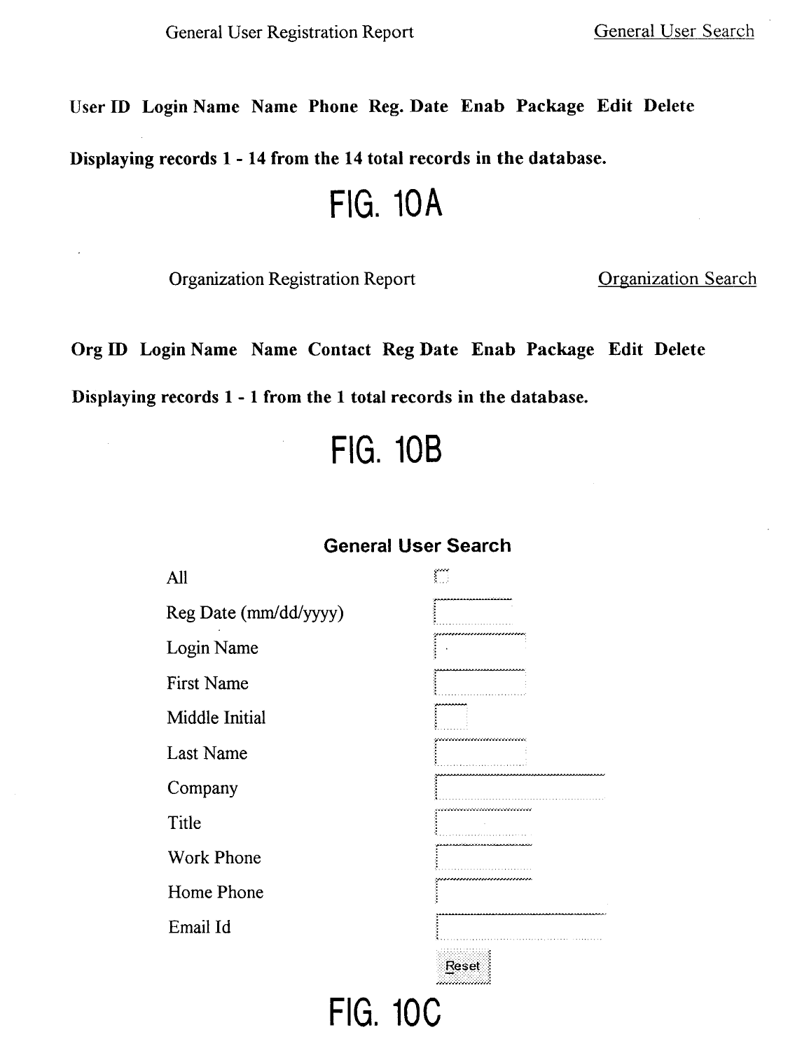

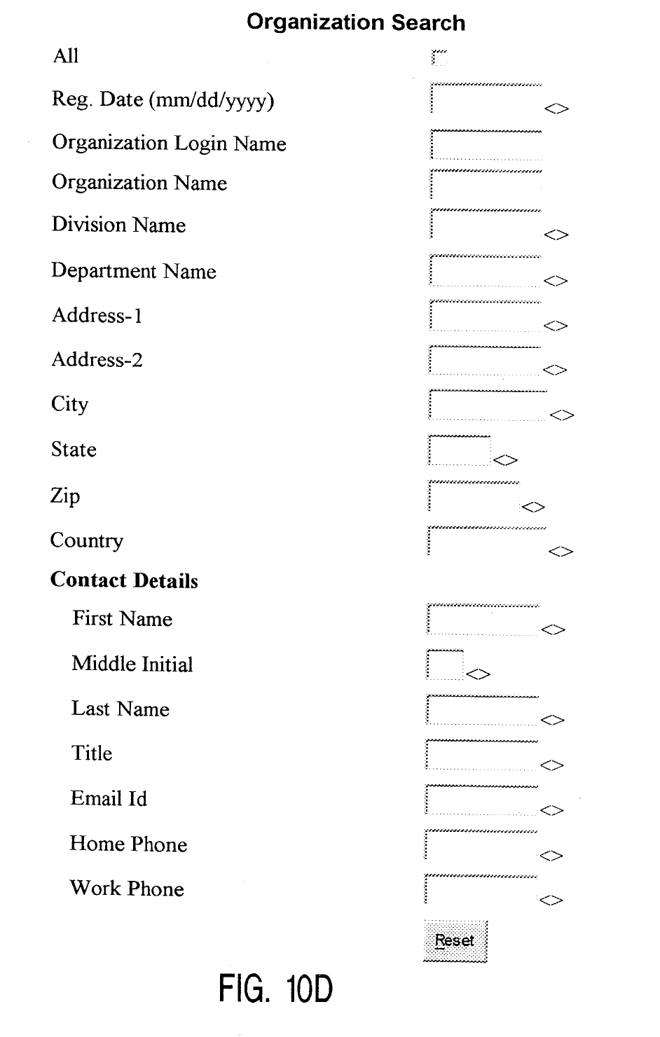

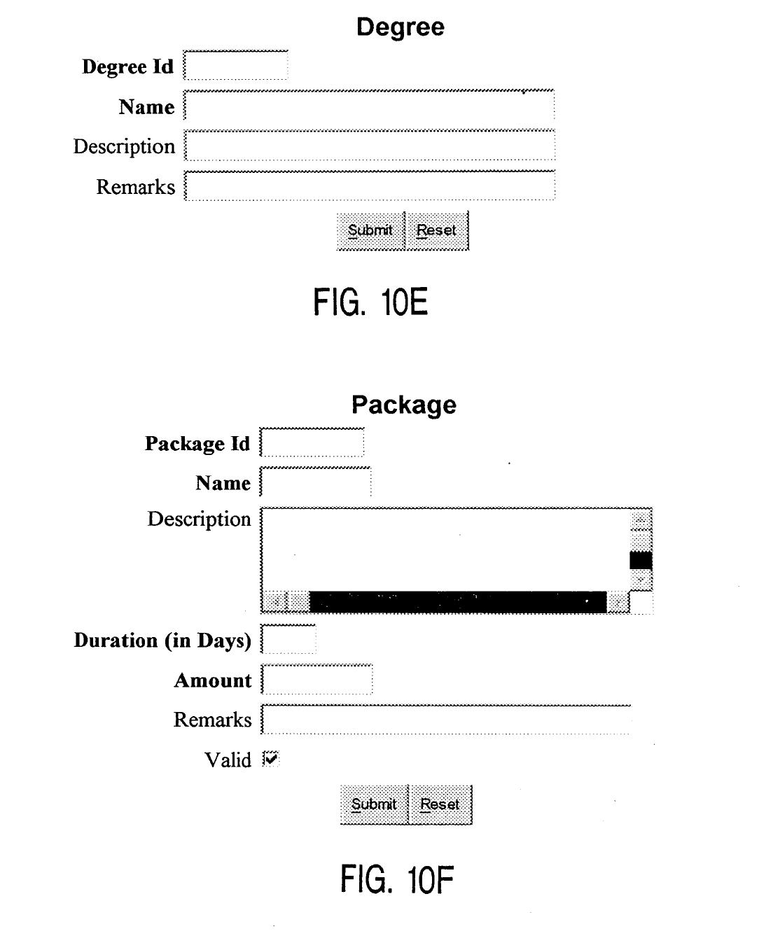

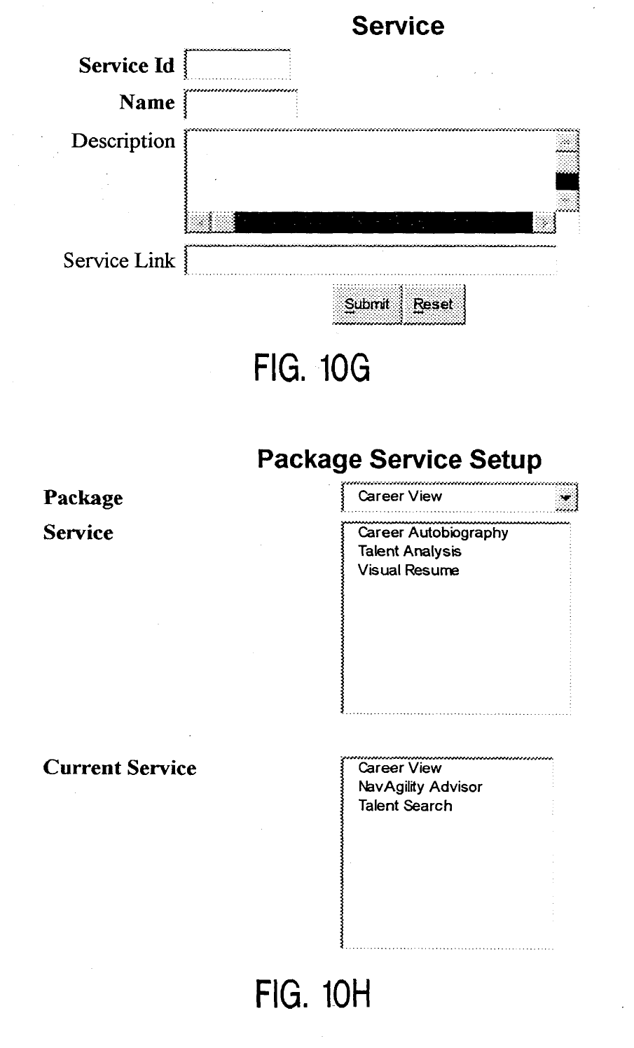

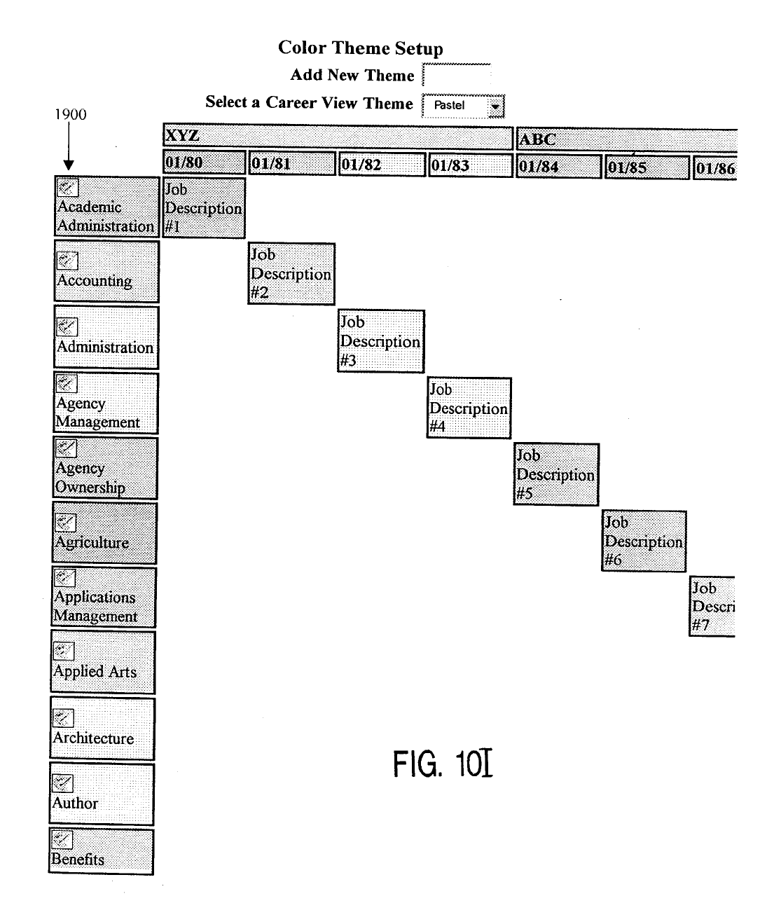

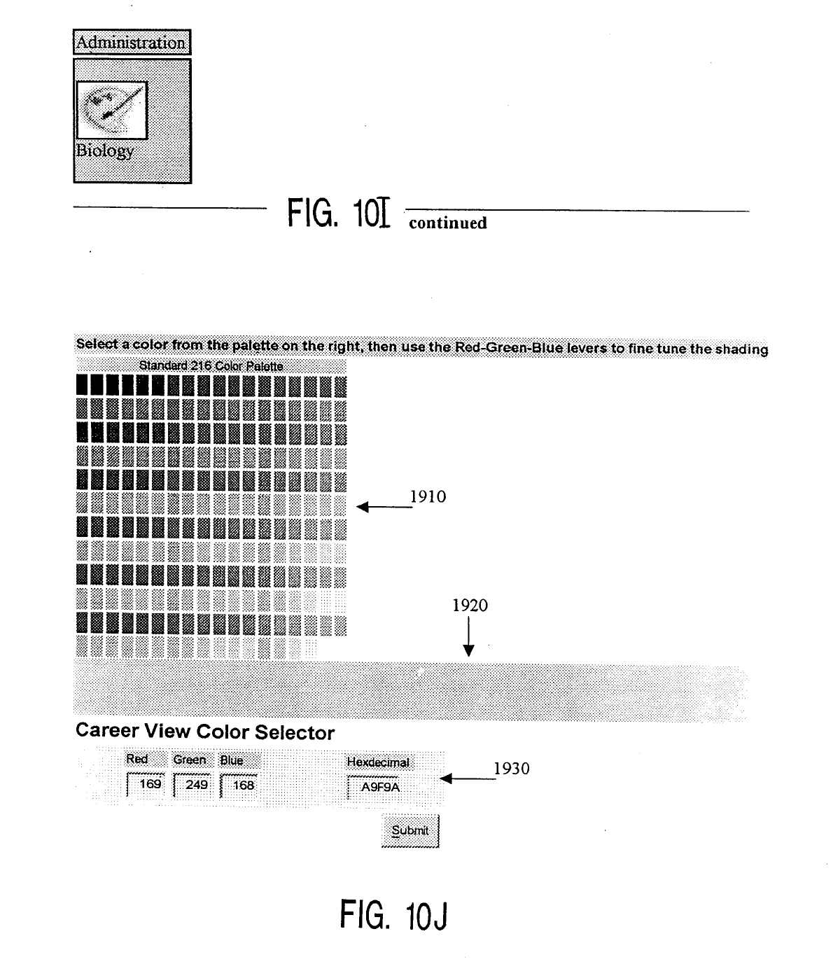

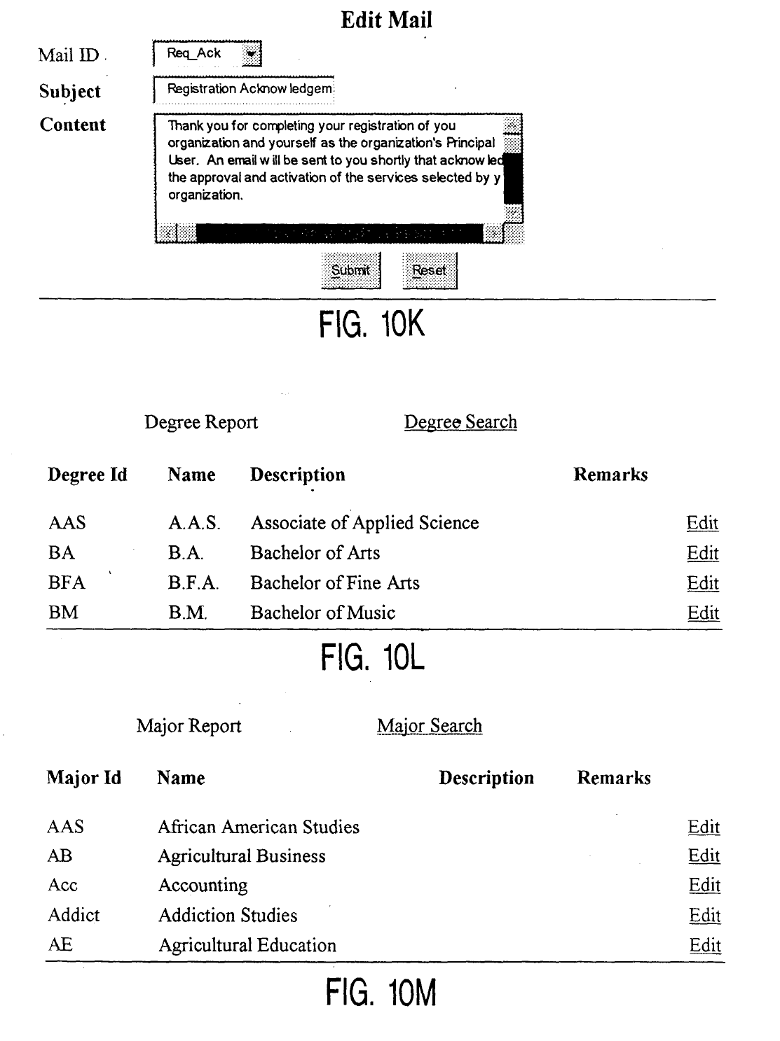

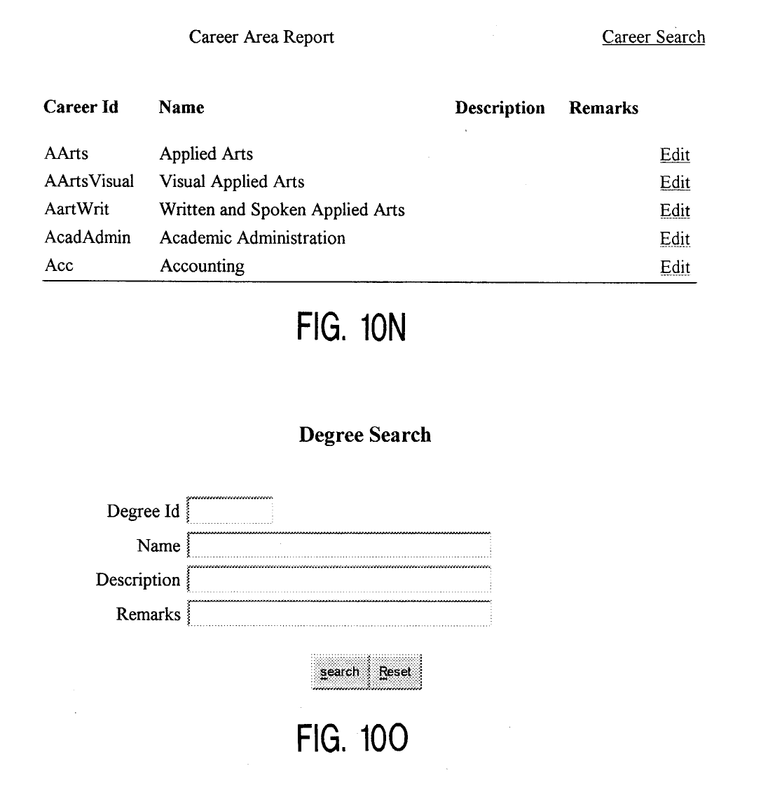

FIG. 31 is the present embodiment of the Display Controls that allow the user to determine which data fields to include in their Visual Resume. The default selections are to include the Project, Roles, Skill, Knowledge, Accomplishment, and Recognition fields in a Visual Resume with the other fields included in the comprehensive Career Autobiography. The controls are provided for each job with the diagram in FIG. 31 only displaying the first job Display Controls as an example.

Common Services:

FIG. 4A is the present embodiment of the General Controls, Career View Privacy Controls, and the Media Link function for attaching video and/or audio links to a Career View. The FIG. 4A General Controls provided include an ability to specify an interest in becoming a mentor or informal career advisor. General Users are those users who develop their Career View outside of any particular company or organization and whose career views are stored in a general user relational data base and accessible by other general users through the talent search functions. Organization Users are those users who develop their Career View within a specific organization or company and whose career views are stored in a separate relational data base domain accessible only by authorized individuals in that organization through the talent search and talent analysis functions. An organization user may allow their career views to be viewed by general users.

These general controls will most often be used by organization users within a specific organization. For example, if a person's Career View is included on the organization's online recruiting site and a candidate indicates a desire to speak informally to that person about their career experiences, the HR organization can broker the connection since the user specified a willingness to act as an informal career advisor. Ethnicity is an optional field that may optionally be used by organizations to enable Talent Search and Analysis to be done by selected ethnic groups. This can help diversity initiatives in organizations by helping to spot inequities in career and job mobility for certain ethnic groups.

In FIG. 4A, the level of general sharing is controlled by the first check box under Career View Privacy Controls. It allows General Users to determine if they will allow their Career View to be included in Talent Search by other General Users and it allows Organization Users to determine if their Career View can be included in Talent Search by other Organization Users in their organization domain and with other General Users outside their organization domain. This enables one-to-many sharing The Career View Privacy Controls also allows the user to control their degree of anonymity by determining via the check boxes whether to include on their Career View their full name and email address, full name only, first name only, or display no name and email address. This allows others the benefit of seeing many Career Views without jeopardizing the anonymity of the Career View owner. Or within an organization, where anonymity is usually not a concern, other employees can directly contact them if they provide full name and email. FIG. 4A also allows a user to optionally attach a video or audio clip to their Career View where it will be available as a link (see FIG. 6A at 604).

FIG. 4B is the screen used to make views visible to others on a more one-to-one basis through a “Send Link” function that allows the user to send an email with embedded web links that provide direct access to their Career View, Visual Resume, or Career Autobiography. For example, one might send an email with a Visual Resume link to a hiring manager or they might send an email to their career coach with a link to their Career Autobiography providing access to more personal and confidential career information. The user can also specify the number of days the link will remain valid so that they control the duration of access that others have to the link they provided.

Database Drawing:

FIG. 5 is a high level diagram of the relational database design for all the data stored and retrieved through the other functions described. All the data captured in screens represented by FIGS. 2A-2C, 3A-3H and the personalized controls captured in screens represented by FIGS. 2D, 31, 4A-4B are stored in a relational database. The present embodiment of the invention is based on Microsoft's SQL Server and uses OD/BC technology for online databases that allow the data stored to be connected to other database products such as DB2, Oracle or Sybase. FIG. 5 represents the high-level database design or the relational structure of the data. The database diagram (FIG. 5) describes the one to many relationships between entities. Each entity is identified in a box on the diagram. For example, the client identity 400 has a one-to-many relationship with the entities of Education 401, and likewise with Professional Development, Volunteer Activities, and Jobs. This means that for one client there can be several database entries for education (e.g. Bachelors Degree and Master Degree), several line items for jobs (e.g. Job 1→N), etc. Similarly, the Jobs entity has a one-to-many relationship with the entities—Project, Roles, Skills, Accomplishments, Knowledge, Recognition, Lessons, Strengths, Weaknesses, Decision Taking, and Decision Leaving. This means there can be several line items for each of those entities within one job.

The database is customizable for a particular company and will depend on the types of talent identification and analysis needs of the company. The database can also be ported to the relational database of choice of the company. These can include, but are not limited to, IBM's DB2, Oracle, Sybase, and Informix based relational database programs. These embodiments change only the technology supporting the database and query and reporting functions and do-not change the design and description of this present invention.

There are two types of databases, one for General Users, those users who developed their Career View outside of an organization sponsor, and the other for Organization Users, those users within a specific organization domain. For example, Company A can have their own separate virtual database of users from within their organization that are only accessible by Talent Search within that organization domain (unless the individual users specified in their Career View Privacy Controls FIG. 4A that their Career View can also be made available to General Users). Likewise, Company B can have their own private organization domain or even a division within Company B can configure a separate organization domain.

Individual Graphical Views and Reports:

FIGS. 6A-6E represent the two-dimensional graphical views of a person's historical career path and a visual history of their career experiences that are generated automatically once the user has completed entering their Career View and Visual Resume data as described above. No user intervention is required unless they choose to customize their Career View look and feel using the customization controls described earlier and represented in FIG. 2D. FIG. 6A represents an example of a Career View that is used to visualize a person's informal career path. The Career View includes the start date for each job 601 as reflected in the columns of each of the graphical views (FIGS. 6A-6E). It also includes the job description that is a short (50 characters or less) description of the type of work in that job. This job description corresponds to the information inside of one “job block” 600 in the Career View (FIG. 6A). The career area is a short (50 characters or less) description of the career area this job falls within. The career areas 602 represent the rows of the Career View and all views (FIGS. 6A-6E). Other data included automatically as part of Career View (FIG. 6A) include the formal education information (i.e. degree, major, institution) 603. It can also include an icon 604 that can be hyperlinked to a video or audio clip of the person telling their career story. The Career View is a very innovative and effective way to represent and articulate a person's career experiences “in a snapshot”. It is very different from a traditional resume since it is a high level visual abstraction rather than a documented record of a person's career.

The Career View (FIG. 6A) is used as a “graphical front cover” or “graphical link menu” of a Visual Resume in order to be able to communicate more traditional resume information to others. Behind each job block 600 on the Career View is hidden resume data for that particular job (see FIG. 7A at 700). By clicking on that block 600 the hidden resume data (FIG. 7A at 700) that is relevant to only that specific job will appear. This allows an individual to include much more high value information about a job without overwhelming the reader with a 10-page resume since the data is hidden. The reader (e.g. hiring manager) can select only the relevant job experiences he or she wants to see details on and ignore the rest while at the same time have access to the complete Visual Resume Report (sample section provided in FIG. 7A) for viewing or printing though the Visual Resume functions provided with the system. The Visual Resume can be sent to others (e.g. hiring manager) via the Send Link function (FIG. 4B) described earlier.

Similarly, the Career View (FIG. 6A) is used as a “graphical front cover” or “graphical link menu” of a Career Autobiography where the complete set of information for each job is accessible by clicking the job block in the Career Autobiography functions. A complete Career Autobiography Report (sample section provided in FIG. 7B) is available for viewing or printing though the Career Autobiography functions provided with the system. In addition, for Career Autobiography there are several other graphical views available in order to help the user gain valuable insights into to their career experiences by visualizing the patterns of projects, roles, skills, and knowledge that has emerged across their career. These Career Autobiography views are created automatically with no user intervention required and are represented in FIG. 6B—Project View, FIG. 6C—Role View, FIG. 6D—Skill View, and FIG. 6E—Knowledge View. In FIG. 6B the job description information included in each job block in the Career View (FIG. 6A at 600) is replaced with project labels 610 identifying key project experiences for that job. Similarly, for FIG. 6C the job block 620 contains role labels for the key roles played in that job, for FIG. 6D the job block 630 contains critical skills developed in that job and in FIG. 6E the job block 640 contains the critical knowledge gained in that job.

Patterns of career experiences (project, role, skills, knowledge) that emerge across a person's career are extremely difficult to spot when buried in a text based traditional resume; however, when portrayed graphically they are easier to recognize. For example, it is easier to spot recurring roles that may be thought of as “natural roles” since one has gravitated to that role across different jobs and even career areas. The graphical views also highlight the transition from one job block to another, so it is easier to spot the valuable transferable roles, skills and knowledge that enabled each transition to take place. These are extremely valuable insights that contribute to the individual's self-knowledge and allow them to be much more articulate when communicating their strengths to others such as hiring managers. It also helps them develop more effective career strategies leading to more satisfying careers and jobs. These Career Autobiography functions allow the present invention to be used as an effective computer-aided career self-assessment tool. The Career Autobiography can also be shared with others (e.g. career coach) via the Send Link function (FIG. 4B) described earlier.

Database Queries and Reports—Talent Search:

As described in the database description section above, if a large number of individuals have their historical career views and data stored in a database then that database can then be queried for specific types of talent. This type of query is called “Talent Search” and it is accomplished via the search screen represented in FIG. 8A. The current embodiment of this invention provides for a Talent Search across the data captured through the Career View input screens (FIGS. 2A-2C). Search criteria can be very broad or very narrow and specific and there are numerous combinations and permutations of searches since the user can specify any combination of: degree, major, year of the degree, name of the college, gender, career area starting point, from/to career area transitions, and organization (i.e. company). These search options are available through drop down menus that reflect the current entries in the database and ensure an effective search capability and high quality search results.

The Talent Search results are formatted in way represented in FIG. 8B where the result (or report) is a list of people (identified by a unique Reference number 800) with Career Views that meet the search criteria. The reference number 800 is also a web link that allows the user to view the full Career View of that particular person, resulting in a view similar to that represented by FIG. 8A. Each row of the results screen represents a unique Career View and the first column always represents the first career area for the person or “Career Starting Point.” 810 This allows for a very quick visual way to see the Career Starting Points for people with similar degrees. The search criteria 820 for the search are listed at the bottom of the search results screen. In the example provided in FIG. 8B, the search criteria are for those with a BS degree (or Bachelor of Science). The present invention includes a report ordered by career sequence but has the flexibility to also offer formatting by job sequence.

Within an organization there are numerous applications of the Talent Search function. It can be used to view a specific type of informal career path. For example, an organization interested in the informal career paths of electrical engineers in their organization can use Talent Search screen (FIG. 8A) to simply select Electrical Engineer in the drop down menu for Majors and submit the search. Or they might be more interested in understanding career transitions of electrical engineers so they would narrow the search by selecting Electrical Engineer from the drop down Major menu, and then selecting a “From” Career Area from that drop down menu and a “To” Career Area from that drop down menu. For example, it could be used to identify those who moved from hardware design to marketing. HR organizations and managers can use Talent Search to identify specific individuals or groups of individuals within an organization such as potential internal candidates for job openings, critical talent, retention risks, people with specific career or job experiences and expertise. For example, if there is a crisis short term need for sales resources within a product division to help drive a strategic sales initiative, Talent Search can be used to see who within the product organization has had sales experience simply by selecting Sales in the drop down Career Area menu and submitting the search. Talent identification can also be used to identify and connect people. An example of this may be by identifying and connecting an employee with an employee willing to act as an informal career advisor or as a mentor.

For General Users, there are also numerous applications for Talent Search. For example, it can be used by academic institutions to view the informal career paths of alumni of specific degree programs from their academic intuition. It can help faculty to adjust their curriculum to include the career needs of students by viewing the typical informal career paths resulting from specific degree programs. The academic institution could also offer more targeted executive and continuing education offerings since they can “see” the current career and job areas of their alumni. It also could be used to help connect alumni with other alumni for job opportunities in a manner that respects the desires and privacy of the individuals involved. This is done through an “authorized talent broker” who can help qualify that a connection is high value to both parties before putting the two individuals in touch with each other.

Similarly, the Talent Search function can be used by headhunters, executive recruiters and employment agencies to find passive job seekers. Individuals (professionals and pre-professionals) can use Talent Search to understand what career options might be open to them as they browse the Career Views of others with similar backgrounds but with different career paths. For example, college students can use Talent Search to identify the various career area starting points of alumni of their academic institution with the same degree and major and if they want to they can narrow the search further to identify only those of their gender and only those within a specific company they are interested in.

While the current embodiment queries only Career View data during a Talent Search, it is extendable to data collected during the Visual Resume/Career Autobiography process through the screens represented in FIGS. 3A-3H. This can dramatically increase the number of applications for Talent Search since the search parameters goes up significantly. For example, you could search for people with specific project or role experiences or with specific skills and knowledge. The multi-purpose nature of the present invention is extended even further as the system can be used for expertise location as a knowledge management application.

Database Queries and Reports—Talent Analysis:

FIG. 9A is the present embodiment of the web based Talent Analysis where a user specifies the report criteria for a specific type of Talent Analysis to conduct on the selected subset of Career View data in the relational database. The Talent Analysis function provides for the analysis of the information and data captured through the Career View input screens (FIGS. 2A-2C). A Talent Analysis is targeted at a specific domain, either a specific organization domain (i.e. company) or the General User domain with the most common application being within an organization domain. The purpose of the function is to help to increase the understanding of the talent dynamics of a relatively large group of individuals. These analyses include, but are not limited to, talent metrics such as career mobility, job mobility and career starting points. Other types of analyses might include career transition patterns and trends, or mobility profiles by affinity group such as executives or entrepreneurs.

The Talent Analysis screen contains the same search criteria as the Talent Search function with one additional field used to select the report desired. The present invention contains three types of Talent Analysis reports as represented in FIGS. 9B-9D. These are examples of three different types of reports that can be generated in the present embodiment of this invention. FIG. 9B is a Career Areas Report of the number of career areas individuals across the organization have had. It provides a basis for a career mobility metric for the organization. FIG. 9C is a Career Area Starting Points Report of the career area starting points for a selected group of individuals across the organization. FIG. 9D is a Jobs Report of the number of jobs individuals across the organization have had. It provides a basis for a job mobility metric for the organization. Each report has a graphic chart component, a data table and table for descriptive statistics. These reports are examples of mobility metrics that HR can use to visualize measure and understand the career and job mobility across an organization.

Because of the number of criteria that can be specified for a specific report there is in actuality, numerous reports within each of the three report types. While the present invention provides these three standard reports it also provides the capability to add additional reports as standard or as custom reports for a specific organization. Some of these additional reports could be frequency of career or job changes (average time interval in between) and the patterns and trends over time, the number of specific from-to transitions, and career ending point distributions (what jobs do people leave from?). The Talent Analysis function of the present invention is also extendable in order to provide for Talent Analysis across a broader set of data. For example, instead of only having Talent Analysis capabilities across Career View data, it can be extended to include data collected during the Visual Resume/Career Autobiography process. This could lead to additional metrics such as competency metrics (e.g. key knowledge domains), or vertical mobility (the number of promotions within a specific career), and promotion intervals.

Companies can benchmark their mobility metrics against their competition in order to differentiate their ability to deliver on a career opportunity or career mobility employer value proposition. This can create a significant competitive advantage for attracting and retaining talent.

Examples of using the Talent Analysis function outside of an organization could be the analysis of external talent markets such as workforce career profiles within industries, within regional economic development zones, affinity groups (e.g. college and corporate alumni), and professional associations. It can include career mobility metrics for college alumni within specific majors. The analyses can also include but are not limited to measures and workforce mobility metrics, workforce vitality, workforce critical talent attraction and retention, workforce entrepreneurship, and workforce executive talent pool.

System Administration:

FIGS. 10A-10N is the present embodiment of the web based System Administration functions available to setup and manage the entire set of functions described earlier. FIGS. 10A-10B are reports that list General Users and Organization Users, respectively. The column headings indicate the fields displayed in the report. In FIG. 10A, a “General User Search” link is also provided to directly link to the General User Search screen (FIG. 10C). In FIG. 10B, an “Organization Search” link is also provided to directly link to the Organization Search screen (FIG. 10D). FIGS. 10C-10D are the search screens used to find a specific General User or Organization User, respectively. These search screens allow for flexible and targeted searches due to the various search fields provided. This function becomes critical when there are very large numbers of General Users or Organizations stored in the database.

FIGS. 10E is a screen used to enter the college degrees users can select when developing their Career View and when they are using Talent Search on degrees. It is representative of other similar screens used to enter the college majors and career areas that can be selected by users when developing their Career View.

FIGS. 10F-10H are screens used to setup the packages and services available for users of the system. In FIG. 10F packages are groups of services that are made available to the user for purchase. Each package is assigned a unique Package Id, Name, Amount (or price) and duration of package validity. Upon expiration of the package, new users can no longer purchase that package but existing users can continue to use the existing package. A Description is included that helps the user (customer) determine if they want to purchase this package. The user (customer) can only purchase a package (of services) and not a service directly. When a user enters the system for the first time after registering or anytime before they have purchased a package, they are presented with a series of menu selections of the packages available that were predefined by the site administrator using the screens represented in FIGS. 10F-10H. When a specific package is selected, the user can review the package description and if they decide to purchase the package they are taken to a payment processing service that in this present invention is provided by PayPal, an eBay Company. After their payment processing is completed in PayPal, they are returned to the system where the services included in that package are now presented as menu options in place of the package menu options. This provides a high degree of flexibility in configuring new offerings without the need for new programming. For example, the site administrator could easily configure a package that includes Career View and Talent Search, or one that includes Career View, Visual Resume and Career Autobiography.

In FIG. 10G, a service can be defined by indicating a unique Service ID and Name. A description is included to help users (customers) determine if they are interested in that particular service. Examples of services are Career View, Visual Resume, Career Autobiography, Talent Search, and Talent Analysis. The Service Link is provided to allow the Site Administrator to create a new service that is not part of the system but allows the user to link to a web page describing the service. For example, a Talent Advisor service can be created where no system services are used but a service menu option is created for that service that links the user to a web page describing the Talent Advisor service. FIG. 10O is the Package Service Setup screen that determines what services belong to each package defined.

FIG. 101 is used to create the multiple color themes that users can select from when developing their Career View. A default Career View is displayed and the user can click on the color palette icon 1900. FIG. 10J is the present embodiment of the color palette function that is used to create the color for each row of the default Career View in FIG. 101. There are three methods of creating color. The first is to select a color directly from the standard color palette 1910 comprised of 216 colors. The second is to use the hexadecimal codes 1930 to select (or identify by unique number) a color. There are also three levers (red-green-blue) that are not shown that can slide in one direction or the other to change the shading in order to fine-tune the color created. This is a very flexible web based function for creating unique colors and colors themes.

FIG. 10K is used to customize various email confirmation messages that are sent automatically from the system to the user upon specific events such as after an organization has been registered. There are five email templates in the present embodiment; one for acknowledging an organization registration (Req_Ack); one for designed an invitation note to send from an organization site administrator to each potential organization user (User_Inv); one for sending an acknowledgement note to an organization site administrator from the system site administrator that they have been approved and the agreed to services have been activated (Re_Acc); one for sending a note to the system site administrator when an organization has registered (Re_Recd); and, one sent to General Users indicating approved access to the package and services they purchased (Gen_Acc). This function is extendable to create other required email templates.

FIGS. 10L-10N are reports of Degrees, Majors and Career Areas, respectively. Each degree, major or career area can be edited by selecting the Edit link on that line. FIG. 10O is a Degree Search screen used to find a specific Degree. It is representative of other similar search screens used to find Majors and Career Areas. This function becomes important as the number of degrees, majors and career areas increases significantly. It should be obvious that changes, additions and omissions may be made in the details and arrangement of parts and steps without departing from the spirit and scope of the invention.

What I claim as my invention is:

1. A talent and career management system comprising:
means for capturing data on an individual, including
general information data
education information data, and
job information data broken down into fields;
means for storing the individual data captured in a data base; and,
means for generating graphical views and reports concerning the individual from the data base.

2. The system of claim 1 including means for displaying the graphical views in formatted tables.

3. The system of claim 1 including means for selecting from the data base the data to be displayed in graphical views and reports.

4. The system of claim 1 including means for attaching a video link to the system.

5. The system of claim 1 including means for attaching an audio link to the system.

6. The system of claim 1 including means for attaching an email link to the system.

7. The system of claim 1 including means for controlling the general information data to be displayed in graphical views and reports.

8. The system of claim 1 including means for storing a plurality of individual data captured in a talent data base.

9. The system of claim 8 including means for querying the talent data base for individuals with specific type talents.

10. The system of claim 9 including means for displaying graphical views of those individuals with specific type talents.

11. The system of claim 8 including means for querying the talent data base for specific type individual data captured.

12. The system of claim 1 including means for editing and deleting individual data captured.

13. The system of claim 2 including means for providing drop down lists of individual data.

14. The system of claim 1 including means for varying the sequence of individual data displayed.

15. The system of claim 1 wherein the means for capturing education data includes entries for degree and major of an individual and a drop down list of degrees and majors from which an individual selects.

16. The system of claim 1 wherein the means for capturing job information data includes an entry for career area and a drop down list of careers from which an individual selects.

17. The system of claim 16 including means for selecting a color theme for a particular career area.

18. The system of claim 1 including means for varying the time sequence of job information displayed.

19. The system of claim 1 including means for displaying a specific job from the job information data captured.

20. The system of claim 1 including input screens for capturing job information data one job at a time.

21. The system of claim 20 wherein an input screen includes entries for project experiences, roles and responsibilities, critical skills acquired and critical knowledge acquired.

22. The system of claim 20 wherein an input screen includes entries for additional information such as major accomplishments, recognition, strengths, weaknesses, lessons learned and decision factors.

23. The system of claim 21 including means for controlling the input screens to be displayed.

24. The system of claim 21 including means for dividing job information data captured into material initially placed in an input screen and material that can be subsequently viewed in an input screen.

25. The system of claim 1 including means for providing packages of captured data available from the system.

26. The method for providing a talent and career management system that includes the steps of:
capturing general information data, education information data and job information data broken down into fields on an individual;
storing the captured individual data in a data base; and,
displaying graphically captured individual data from the data base.

27. The method of claim 26 including displaying the graphical views in formatted tables.

28. The method of claim 26 including selecting from the data base the data to be displayed in graphical views and reports.

29. The method of claim 26 including attaching a video link to the system.

30. The method of claim 26 including attaching an audio link to the system.

31. The method of claim 26 including attaching an email link to the system.

32. The method of claim 26 including controlling the general information data displayed in graphical views and reports.

33. The method of claim 26 including storing a plurality of individual data captured in a talent data base.

34. The method of claim 33 including querying the talent data base for individuals with specific type talents.

35. The method of claim 34 including displaying graphical views of those individuals with specific type talents.

36. The method of claim 33 including querying the talent data base for specific type individual data captured.

37. The method of claim 26 including editing and deleting individual data captured.

38. The method of claim 26 including varying the sequence of individual data displayed.

39. The method of claim 26 including providing the job information data with an entry for career data and providing a drop down lists of careers from which an individual selects.

40. The system of claim 39 including selecting a color theme for a particular career area.

41. The method of claim 26 including varying the time sequence of job information displayed.

42. The method of claim 26 including displaying a specific job from the job information data captured.

43. The method of claim 26 including providing input screens for displaying captured job information one job at a time.

44. The method of claim 26 including providing the input screens with entries for project experiences, roles and responsibilities, critical skills acquired and critical knowledge acquired.

45. The method of claim 44 including providing the input screens with additional information such as major accomplishments, recognition, strengths, weaknesses, lessons learned and decision factors.

46. The method of claim 44 including controlling the input screens to be displayed.

47. The method of claim 43 including dividing the job information data captured into material initially placed in an input screen and material that can be subsequently viewed in an input screen.

48. The method of claim 26 including providing packages of captured data available from the system.
